(19) United States
(12) Patent Application Publication
(10) Pub. No.: US 2026/0002882 A1
(43) Pub. Date: Jan. 1, 2026

(54) QUALITY CONTROL METHOD AND SYSTEM FOR PRODUCTION LINE, AND MANUFACTURING PLATFORM

(71) Applicants: BEIJING BOE TECHNOLOGY DEVELOPMENT CO., LTD., Beijing (CN); BOE Technology Group Co., Ltd., Beijing (CN)

(72) Inventors: Yue Kong, Beijing (CN); Guangwei Huang, Beijing (CN)

(73) Assignees: BEIJING BOE TECHNOLOGY DEVELOPMENT CO., LTD., Beijing (CN); BOE Technology Group Co., Ltd., Beijing (CN)

(21) Appl. No.: 18/992,808

(22) PCT Filed: Apr. 28, 2023
(86) PCT No.: PCT/CN2023/091727

§ 371 Date: Jan. 9, 2025

(51) Int. Cl. G01N 21/88

(52) U.S. Cl. CPC G01N 21/8851; G01N 21/8803; G01N 2021/8877; G01N 2021/8887

(57) ABSTRACT

A quality control method includes: in response to triggering of a first preset condition, performing quality inspection on a plurality of to-be-inspected objects produced on a target production line; feeding back a result of the quality inspection to a control object associated with the target production line, the control object being used for controlling a process flow of the target production line; and in response to a second preset condition triggered on the control object, regulating the target production line based on a quality inspection result of at least one to-be-inspected object, where the quality inspection includes: performing at least one image acquisition on the to-be-inspected objects produced by the target production line, and inputting at least one acquired image into a defect detection model so as to perform the quality inspection on the to-be-inspected objects.

### TECHNICAL FIELD

The present disclosure relates to the technical field of manufacturing and more particularly, to a quality control method and system for a production line, and a manufacturing platform.

### BACKGROUND

In the field of production and manufacturing, a plurality of production lines are involved to produce devices, and the devices produced may include display panels, chips, and the like. In the process of manufacturing these devices, as well as when the devices are manufactured, quality inspection is performed on the devices, so as to eliminate non-conforming devices, whereby the devices are qualified products when leaving the factory.

Currently, the quality inspection of devices is inefficient in the field of manufacturing.

### SUMMARY

In a first aspect, the present disclosure provides a quality control method for a production line, and the method includes:
in response to triggering of a first preset condition, performing quality inspection on a plurality of to-be-inspected objects produced on a target production line;
feeding back a result of the quality inspection to a control object associated with the target production line, the control object being used for controlling a process flow of the target production line; and
in response to a second preset condition triggered on the control object, regulating the target production line based on a quality inspection result of at least one to-be-inspected object;
where the quality inspection includes: performing at least one image acquisition on the to-be-inspected objects produced by the target production line, and inputting at least one acquired image into a defect detection model, so as to perform the quality inspection on the to-be-inspected objects.

In order to solve the above problems, in a second aspect, the present disclosure provides a quality control method for a production line, and the method includes:
performing at least one image acquisition on to-be-inspected objects produced on a
inputting at least one acquired image into a defect detection model, so as to perform quality inspection on the to-be-inspected objects through the defect detection model; and
regulating the target production line based on a quality inspection result of at least one of the to-be-inspected objects on the target production line.

In a third aspect, the present disclosure provides a quality control system, including an infrastructure layer and a quality control layer;
the infrastructure layer comprises a plurality of first devices, and different first devices are configured to provide different services required by the quality inspection; and
the quality control layer is in communication with the infrastructure layer and is configured to perform the quality control method according to the first aspect or the second aspect.

In a fourth aspect, the present disclosure provides a manufacturing platform, including a computer integrated system, and the quality control system according to the third aspect, the quality control system is integrated into the computer integrated system, and the computer integrated system is provided with a production information management system;
where the quality control system is in communication with the production information management system;
the quality control system is configured to perform the quality control method according to the first aspect or the second aspect, and send a debugging instruction to the production information management system when regulating the target production line; and
the production information management system is configured to regulate a process device in the target production line according to the debugging instruction.

In a fifth aspect, the present disclosure provides a computer-readable storage medium, where a computer program stored thereon causes a processor to execute the quality control method for the production line as described in the first aspect of the present disclosure, or the computer program stored thereon causes the processor to execute the quality control method for the production line as described in the second aspect of the present disclosure.

The embodiment of the present disclosure also discloses an electronic device, including a memory, a processor, and a computer program stored on the memory and executable on the processor; the processor implements the quality control method for the production line as described in the first aspect when executed.

In the technical solution of embodiments of the present disclosure, the quality inspection may be performed on a plurality of to-be-inspected objects produced on a target production line in response to a triggered quality inspection function. In addition, quality inspection results of the to-be-inspected objects are displayed on a display interface, and the target production line may be regulated based on the quality inspection result of at least one to-be-inspected object with regard to a debugging function triggered for the displayed quality inspection results. The quality inspection of the present disclosure includes: performing at least one image acquisition on the to-be-inspected objects on the target production line, and inputting at least one acquired image into a defect detection model so as to perform the quality inspection on the to-be-inspected objects.

The quality inspection may be started on the to-be-inspected objects on the target production line in response to the triggered quality inspection function, and a result of the quality inspection may be fed back to a control object associated with the target production line. The control object at least includes a client on the target production line and a display interface corresponding to the target production line. In response to the debugging function triggered on the control object, the target production line is regulated based on the quality inspection result of at least one to-be-inspected object, whereby the quality inspection on the to-be-inspected object in the present disclosure may be deeply implemented into a production line for producing the to-be-inspected objects, so as to adjust the process flow and the like of the production line in combination with the quality inspection condition of the to-be-inspected objects. Therefore, the yield problem of the to-be-inspected objects can be solved from the source of producing the to-be-inspected objects, such as process parameters and process devices, and the production cost consumed due to the abandonment of the to-be-inspected objects with poor quality can be reduced.

The above description is only an overview of the technical solution of the present disclosure. In order to have a clearer understanding of the technical means of the present disclosure, it can be implemented according to the content of the specification. In order to make the above and other purposes, features, and advantages of the present disclosure more obvious and easier to understand, the specific implementation methods of the present disclosure are listed below.

### BRIEF DESCRIPTION OF THE DRAWINGS

In order to provide a clearer explanation of the technical solutions in the embodiments of the present disclosure or related art, a brief introduction will be given below to the accompanying drawings required in the descriptions of the embodiments or related art. It is obvious that the accompanying drawings in the following description are some embodiments of the present disclosure. For those skilled in the art, other accompanying drawings can be obtained based on these drawings without creative labor. It should be noted that the proportions in the accompanying drawings are only for illustrative purposes and do not represent the actual proportions.

FIG. 1 shows a schematic diagram of an implementation environment of a manufacturing platform according to an embodiment of the present disclosure;

FIG. 2 shows a schematic framework diagram of a quality control system according to an embodiment of the present disclosure;

FIG. 2a is a schematic diagram of a list showing that a detection device management unit manages servers;

FIGS. 2b-2d show a schematic interface diagram showing that a user management unit manages user information;

FIG. 2e shows a schematic diagram of work division of modules related to quality inspection in a quality control system;

FIG. 3 is a flow chart showing the steps of a quality control method for a production line according to an embodiment of the present disclosure;

FIG. 4 shows a schematic interface diagram of a first configuration interface according to an embodiment of the present disclosure;

FIG. 5 is a schematic diagram of a policy architecture showing that how to perform quality inspection under the quality control system shown in FIG. 2;

FIG. 6 is a flow chart showing construction steps of a defect detection model;

FIG. 7 shows a schematic interface diagram of a third configuration interface when constructing a defect detection model;

FIG. 8 shows an interface for obtaining a second data set;

FIG. 9 is a flow chart showing the steps of obtaining a second data set according to an embodiment of the present disclosure;

FIG. 10a-FIG. 10c show schematic interface diagrams of statistics on quality inspection results;

FIG. 11 is a flow chart showing the steps of performing statistics on quality inspection results according to an embodiment of the present disclosure;

FIG. 12 is a flow chart showing the steps of regulating a target production line according to an embodiment of the present disclosure;

FIG. 13 is a complete flow chart of quality control according to an embodiment of the present disclosure;

FIG. 14 shows a schematic interface setting diagram of a quality control system according to an embodiment of the present disclosure;

FIG. 15 is a flow chart showing the steps of a quality control method for a production line according to an embodiment of the present disclosure; and

FIG. 16 is a flow chart showing the steps of adjusting a quality inspection process in real time according to an embodiment of the present disclosure.

### DETAILED DESCRIPTION

In order to clarify the purpose, technical solution, and advantages of the embodiments of the present disclosure, the following will provide a clear and complete description of the technical solution in the embodiments of the present disclosure in conjunction with the accompanying drawings. Obviously, the described embodiments are a part of the embodiments of the present disclosure, not all of them. Based on the embodiments of the present disclosure, all other embodiments obtained by persons skilled in the art without creative labor fall within the scope of protection of the present disclosure.

In the related art, it is necessary to perform quality inspection on produced devices in the field of production and manufacturing. One quality inspection mode is to manually perform quality inspection on the devices, which is dependent on the experience of workers, has low accuracy and is not suitable for devices with relatively fine defects. Another quality inspection mode is to use artificial intelligence (AI) for quality inspection, for example, using a professional neural network model for quality inspection of the devices after photographing. However, the current quality inspection scheme using AI is not deeply implemented to factories to be in combination with production lines, which is still isolated from the production lines.

The application of AI to the quality inspection of the factories needs to face the following practical problems:
1. The production line generally involves a plurality of industrial control systems, such as a control system of a process device on the production line and a transmission control system of the production line. Each industrial control system has different functions. When AI is applied for the quality inspection, AI needs to be combined with the plurality of industrial control systems, and additional system integration and development costs are needed.
2. In the field of manufacturing, the production efficiency is a very important device production index, which means that it is necessary to find out unqualified devices in the quality inspection in time and defects in the production line, and the real-time requirements of the quality inspection are high. However, in the related art, based on the reason of the first problem, the coupling between the quality inspection and the production line is difficult, resulting in a poor real-time quality inspection.
3. In the field of manufacturing, it is necessary to manage and control the industrial control devices on a plurality of production lines in an integrated manner, so as to improve the level of automatic management and control of the production lines. However, the current industrial control devices are generally independent from each other and controlled by respective sets of systems, and the industrial control devices between the production lines cannot communicate with each other, whereby when AI is specifically implemented, it is necessary to perform targeted development for different production lines, thereby increasing the development cost.
4. When AI is used for the quality inspection, a large amount of labeled data is required. However, in the field of manufacturing, devices needed to be subjected to the quality inspection may be finished products or semi-finished products, and data confidentiality is generally required, which means that it is difficult to obtain a large amount of labeled data and the labeled data needs to be confidential, thereby becoming a difficult problem for implementation of AI to the factories for the quality inspection.
5. In the field of manufacturing, such as the field of manufacturing of chips, display panels, and other devices, the professional level of technicians performing the quality inspection is narrow, and the application level of AI is low, which results in that the technicians cannot proficiently use AI to perform the quality inspection, and that AI requires a higher professional level of workers when being implemented into factories, thereby intangibly raising the technical threshold for implementation.

Based on the above practical problems, most of applications of AI to the quality inspection of the devices in the factories are still at the level of theoretical research, and less AI can be truly implemented and will also face the above practical problems after being implemented, whereby the maintenance costs after implementation are higher, and the contribution to improving the manufacturing efficiency and product yield of devices produced in factories is still low.

In view of this, the present disclosure provides a scheme that enables AI to be implemented into a production line of a factory, and can reduce a technical threshold for implementation and improve the quality inspection efficiency. In particular, a quality control method for a production line is provided. The quality control method may include: in response to triggering of a user, directly performing the quality inspection on a to-be-inspected object by using a neural network model, and feeding back a quality inspection result to a production line, whereby the production line regulates parameters such as a process flow on the production line based on the quality inspection result, thereby achieving the purpose of timely rectification and debugging on defects of the production line based on the quality inspection result, and further ensuring that the to-be-inspected object is technologically adjusted in time in the production process, so as to ensure the production quality of the to-be-inspected object. As such, the quality control method of the present disclosure may have the following advantages:
1. When AI (defect detection model) is used for the quality inspection, since the quality inspection result is fed back to a control object associated with a target production line, the combination of the quality inspection and the target production line is achieved. At the same time, regulation may be directly performed in response to a second preset condition triggered on the control object of the target production line, whereby when AI is implemented into the production line, as long as a communication connection path between the quality inspection process and the control object corresponding to the target production line is developed, the system integration development cost involved is low.
2. The coupling degree between the quality inspection of the to-be-inspected object and the production line is improved, and the higher real-time quality inspection is enabled, so as to adjust the defects of the production line in real time.
3. When AI is implemented into the quality inspection of the to-be-inspected object, a relatively simple trigger condition, such as a first preset condition and a second preset condition, may be set, so as to facilitate a worker to manipulate AI, thereby reducing the professional level requirements of the worker on AI. Therefore, the worker can operate AI with a low technical threshold for the quality inspection. At the same time, the quality inspection result may be used with a low technical threshold to regulate the production line. Among them, the present disclosure further reduces the technical threshold for its use by reducing the difficulty in setting parameters required for AI, as described in the subsequent embodiments.

Hereinafter, the quality control method for the production line of the present disclosure will be described in detail.

### Embodiment 1

In order to further understand the quality control method proposed in the present disclosure, firstly, a system framework designed for the quality control method in the embodiments of the present disclosure is described:

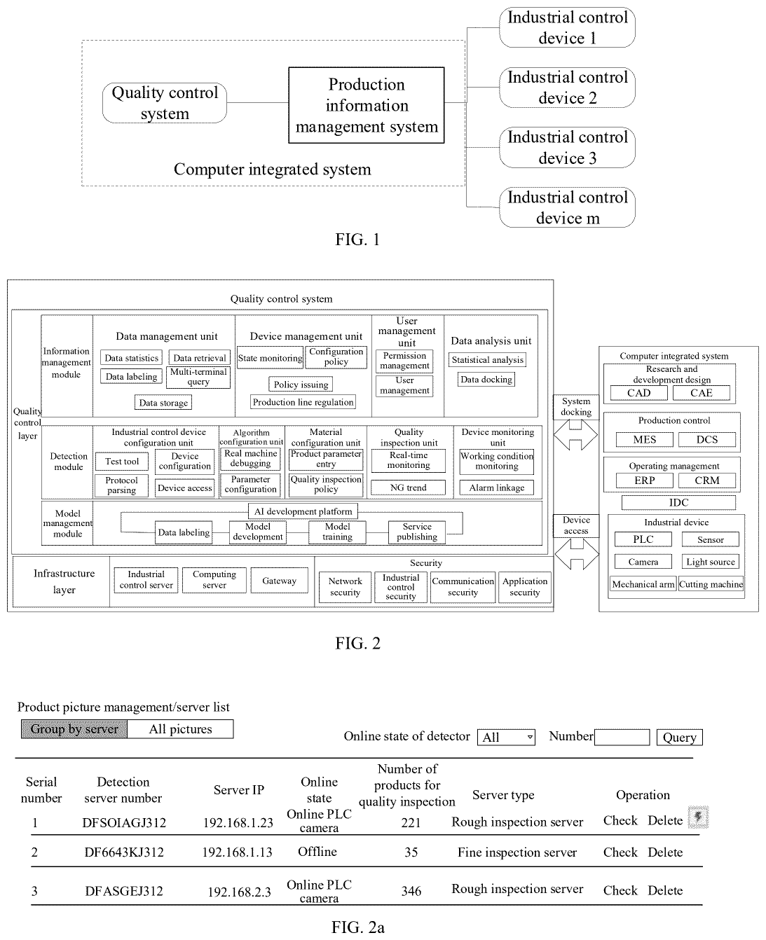

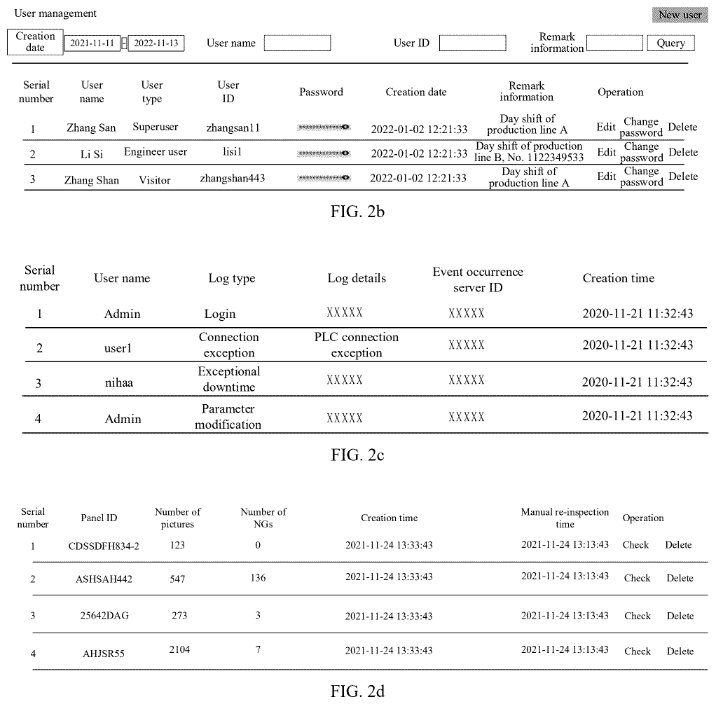

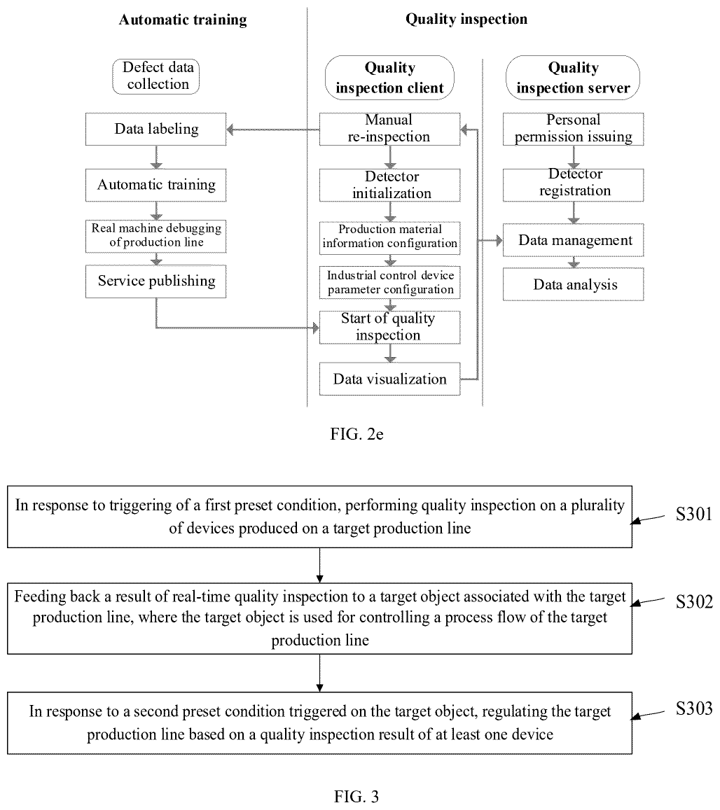

With reference to FIG. 1 and FIG. 2, FIG. 1 shows a schematic diagram of an implementation environment of a manufacturing platform proposed by the present disclosure, and FIG. 2 shows a schematic framework diagram of a quality control system in a manufacturing platform. The manufacturing platform includes a quality control system and a computer integrated system. The quality control system is integrated into the computer integrated system, and the computer integrated system is provided with a production information management system (MES).

The quality control system may be in communication with the production information management system.

The quality control system may be configured to perform a quality control method in subsequent Embodiment 2, and send a debugging instruction to the production information management system when regulating a target production line.

The production information management system may be configured to regulate a process device in the target production line according to the debugging instruction.

The manufacturing platform may include a plurality of production lines, different production lines may be used for producing different to-be-inspected objects, or different production lines are used for performing different processes required in the production process of the to-be-inspected objects.

The quality control system may be configured to perform quality control on a plurality of production lines. Specifically, the quality inspection is performed on the to-be-inspected objects based on images obtained by performing image acquisition on the to-be-inspected objects completed by each production line, and a process device of the production line may be regulated according to a quality inspection result, so as to achieve the purpose of performing centralized management and control on the production quality of the plurality of production lines.

The quality control system is mainly integrated into the computer integrated system, which may perform information interaction with the production information management system as an independent system. The production information management system integrates management threads of a plurality of production lines to control the start, stop, and process flow of the production lines through the management threads. The production line generally has some process devices, and different process devices may complete different process preparations in the production of the to-be-inspected objects.

In some embodiments, the manufacturing platform further includes: a plurality of second devices. The plurality of second devices are in communication with the quality control system and are configured to perform information acquisition on the to-be-inspected objects on the production line. The information acquisition includes at least image acquisition.

In some specific implementations of this embodiment, the plurality of second devices may be controlled by the production information management system, which may include part of the process devices or all of the process devices on the production line. The second devices are mainly configured to acquire information related to the quality inspection during the quality inspection. As shown in FIG. 2, industrial devices included on the production line may include: a cutting machine, a programmable logic controller (PLC), a sensor, a camera, a light source, and a mechanical arm. The PLC, the sensor, the camera, the light source, and the mechanical arm are the second devices for information acquisition. The cutting machine is a device for cutting a display panel, which may not be configured for information acquisition during the quality inspection. However, the cutting machine may update own process parameters in response to a regulation instruction fed back by the quality control system according to the quality inspection result, so as to realize the regulation of the cutting process.

In still other specific implementations of this embodiment, the plurality of second devices may also include a server for controlling and managing process devices. The server may perform control and management with a plurality of process devices performing the same information acquisition on a plurality of production lines. For example, for panel cutting, there are three production lines. If two cameras are provided for each production line, there are at least six cameras, and the six cameras may be controlled and managed by one server.

The servers in the plurality of second devices may be deployed in the production information management system 300, which may be used as a node device to control and manage the devices for information acquisition on the plurality of production lines.

In this way, when the quality control system is implemented, the plurality of second devices on the production lines may access the quality control system. That is, the quality control system is uniformly managed and controlled. In particular, the management and control may be as described in the subsequent embodiments: parameter configuration, state monitoring, and the like. In this way, no matter for the quality inspection or for the regulation of the production line, there is no need to communicate the industrial control devices between the production lines, and control layers are communicated through the quality control system. Therefore, the development cost of the quality control system in implementation is reduced, which is sufficient to cope with the practical problem in point 3.

In still other embodiments, the plurality of second devices include: an image acquisition apparatus, a controller, a sensor, and a mechanical arm. The controller is connected to the image acquisition apparatus through the mechanical arm, and the sensor is connected to the controller.

The sensor is configured to detect whether the to-be-inspected objects arrive.

The controller is configured to control the image acquisition apparatus to move when the to-be-inspected objects arrive, so as to perform at least one image acquisition on the to-be-inspected objects through the image acquisition apparatus.

The sensor may send a trigger signal to the controller when it is detected that a to-be-inspected object arrives. According to the trigger signal, the controller controls the mechanical arm to drive the image acquisition apparatus to move according to a pre-configured parameter corresponding to the controller. The image acquisition apparatus may perform at least one image acquisition on a to-be-detected region of the to-be-inspected object according to the pre-configured parameter corresponding to the image acquisition apparatus during the movement.

The parameter corresponding to the image acquisition apparatus may include an image acquisition frequency, resolution, and the like.

Thus, as long as communication between AI and the industrial control devices in the industrial control system is established, the existing devices in the industrial control system may be used, thereby reducing the system development cost.

It should be noted that the to-be-inspected objects mentioned in the present disclosure may be various devices produced by the target production line, such as devices for electronic devices and devices for production and living. The devices for electronic devices may include display panel devices such as display panels and array substrates, and may also include miniature electronic devices such as diodes and semiconductors. The devices for production and living may include appliances such as ceramic appliances, stainless steel appliances, molds, and glasses, hardware, and textiles such as cloth.

FIG. 2 shows a schematic framework diagram of a quality control system in an example. The quality control system includes an infrastructure layer and a quality control layer.

The infrastructure layer includes a plurality of first devices, and different first devices are configured to provide different services required by the quality inspection. The quality control layer is in communication with the infrastructure layer and is configured to perform a quality control method.

The quality control layer may be understood as a software backbone in the quality control system for performing quality control in a production line in combination with a computer program on the hardware support provided by the infrastructure layer.

In this embodiment, the first device may include: a communication bridge device for establishing communication between the second device and the quality control layer in the production information management system, for example, including a gateway and an industrial control server, as well as a server for providing an algorithm service, a data analysis service, and a storage service for the quality inspection.

In some embodiments, the quality control layer may also be communicatively connected to the plurality of second devices on the production line, configured to access the plurality of second devices, and configured to perform parameter configuration related to the quality inspection on the plurality of second devices. The plurality of second devices are configured to perform information acquisition on the to-be-inspected objects on the production line. The information acquisition includes at least image acquisition.

The second devices, as described in the above-mentioned embodiment, may be controlled by the production information management system, which may be part or all of process devices on the production line, and mainly configured to acquire information related to the quality inspection during the quality inspection. A server for controlling and managing the process devices may also be included.

The second device may be the same as the first device in terms of hardware structure, but the second device specifically refers to a device used for image acquisition, production line site management and control, and the like on the production line in the present disclosure, while the first device specifically refers to a server, a cluster, or the like supporting the quality control system in the present disclosure.

With such an implementation, the quality control system may reuse the existing industrial control devices on the production line to acquire information required for the quality inspection through the existing industrial control devices. Therefore, when the quality control system is implemented on the production line, the implementation cost can be reduced. Since no new device needs to be introduced, access, protocol matching and other developments for the newly introduced device can be avoided, thereby achieving implementation with a low technical threshold.

The infrastructure layer is a first device for providing quality control for the quality control system. In one example, the first device may include a gateway and a server. There may be at least one gateway, and there may also be at least one server.

Different servers are configured to provide different business services for the production line, where the business services at least include: regulation services and quality inspection services.

The regulation services may refer to: based on a quality inspection result of at least one to-be-inspected object on a production line, regulating a process device of the production line. The quality inspection services may refer to: the quality inspection of the to-be-inspected objects on the production line.

As shown in FIG. 2, the server providing the regulation services in the first device is referred to as an industrial control server, and the server providing the quality inspection services is referred to as a computing server.

As shown in FIG. 2, in the infrastructure layer, the plurality of first devices may include a gateway and an industrial control server, both of which are configured to construct a communication bridge for communication between the second device and the quality control layer in the production information management system. In particular, the gateway is configured to establish a communication link between the second device and the computing server, and establish a communication link between a process device in the production line and the industrial control server. The process device may include both the second device and a device for performing device production.

For example, image information acquired by the second device on the to-be-inspected objects may be sent to the computing server via the gateway, and the computing server performs the quality inspection based on images. Based on the quality inspection result, the quality control layer outputs a regulation instruction to the industrial control server, and the industrial control server sends the regulation instruction to the process device on the corresponding production line in the production information management system, such as a cutting machine, so as to adjust a process parameter of the cutting machine. And the quality control layer may also send an instruction for adjusting a configuration parameter of the second device to the industrial control server, and the industrial control server may send the configuration parameter to the second device, whereby the second device acquires information according to the configuration parameter. In a case that the industrial control server sends the configuration parameter to the second device, the industrial control server may send the configuration parameter to the server in the first devices for controlling the process device, thereby sending the configuration parameter to the device on the corresponding production line through the server.

In some embodiments, the at least one server includes a quality inspection server configured with a defect detection model, and the quality inspection server is configured to input the image into the defect detection model after receiving an image acquired by the second device, so as to perform the quality inspection on the plurality of to-be-inspected objects. Among them, the second device is located on the production line.

In this embodiment, the at least one server may include the above-mentioned computing server, i.e. a quality inspection server, may further include a data server for data storage and analysis and the above-mentioned industrial control server, and in some other examples, may further include a training server for model training and updating. The quality inspection server and the industrial control server may be deployed at a node of the quality control system, that is, deployed around the node in a distributed manner, such as near the second device. At this moment, the servers are applicable to distributed factories, such as branch factories distributed in different regions, whereby the quality inspection server and the second device constitute a local area network, and the data server for data storage and analysis and the training server may be deployed on the cloud to provide additional services or functionality.

Certainly, the quality inspection server and the training server may also be deployed at the cloud to provide fast quality inspection services through cloud-integrated computing resources, while the data server providing data storage and analysis and the industrial control server may be deployed at the node of the quality control system, that is, deployed around the node in a distributed manner, such as near the second device, so as to provide faster quality inspection result query.

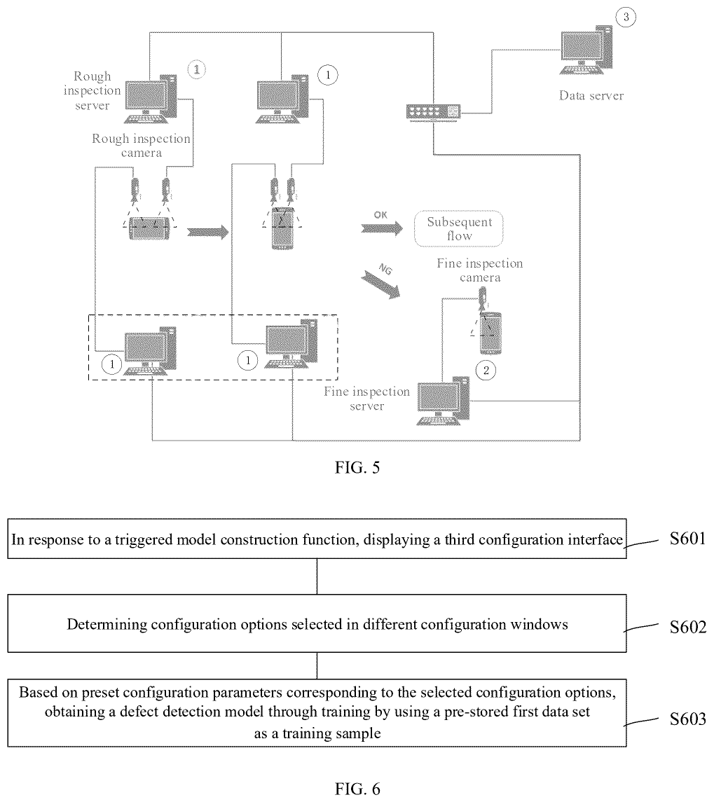

As shown in FIG. 5, at least one server may include a data server for data storage and analysis. The quality inspection server may be in communication with the data server and send the quality inspection result to the data server for storage. The data server may support statistics, query, and retrieval of the quality inspection result based on the stored quality inspection result.

Different quality inspection servers may be configured with different defect detection models. In this case, the quality inspection may be performed on defects of different types of to-be-inspected objects through a plurality of quality inspection servers. It will be understood that the types of defects that need to be inspected on the to-be-inspected objects produced by different production lines may be the same. In this case, different production lines may share the same defect detection model for the quality inspection. Alternatively, the quality inspection may be performed on the to-be-inspected objects produced by different production lines through different quality inspection servers. In this case, each production line may correspond to an independent quality inspection server, so as to perform an independent quality inspection.

Different quality inspection servers may configure defect detection models with different detection precisions. In this case, a defect detection model with a lower detection precision may be configured to roughly inspect the to-be-inspected objects during the quality inspection, and a defect detection model with a higher detection precision may be configured to finely inspect the to-be-inspected objects during the quality inspection, whereby the quality inspection efficiency can be improved through rough inspection and fine inspection.

As shown in FIG. 5, at least one server may include a data server (3) for data storage and analysis. The quality inspection server may include a plurality of first quality inspection servers (1) and a second quality inspection server (2). The plurality of first quality inspection servers (1) may be configured to roughly inspect the to-be-inspected objects. The second quality inspection server (2) may finely inspect the to-be-inspected objects which have failed the quality inspection.

Four first quality inspection servers (1) are shown in FIG. 5, and the four first quality inspection servers (1) may be deployed on different production lines for roughly inspecting the same defect of the to-be-inspected objects produced by different production lines, and may also be deployed on the same production line for roughly inspecting different defects of a to-be-inspected object produced by the production line. Alternatively, the four first quality inspection servers (1) may be deployed on the same production line for performing distributed rough inspection on defects of a plurality of to-be-inspected objects produced by the production line.

The second quality inspection server (2) may be configured to finely inspect the to-be-inspected objects of different defect types, and may be deployed at a master node, so as to finely inspect the to-be-inspected objects which have failed the quality inspection on a plurality of different production lines.

As shown in FIG. 2, in one embodiment, the quality control layer may include an information management module, a detection module, and a model management module.

The information management module may be configured to perform at least one of the following information processing: processing data generated during the quality inspection, processing state information of the plurality of first devices, and processing user information of a user.

The detection module may be configured to perform at least one of the following during the quality inspection on the to-be-inspected objects: parameter configuration during the quality inspection, quality inspection on the to-be-inspected objects, quality inspection error correction on the to-be-inspected objects, and access configuration of a plurality of devices.

The model management module may be configured to construct the defect detection model.

The data generated during the quality inspection may include: image data obtained by performing image acquisition on the to-be-inspected objects during the quality inspection, result data of the quality inspection, parameter data of parameter configuration to be performed during the quality inspection, and the like.

The state information of the plurality of first devices may refer to: state information generated by monitoring the first device, and the processing thereof may include: display, analysis, and alarm processing of the state information.

The user information of a user may refer to information of a user logging in the quality control system, including user account information, login information, and the like. The processing thereof may include: permission processing, account modification processing, and the like. It should be noted that the user herein may include ordinary login users and administrator users.

In some embodiments, the information management module may further include a user management unit. The user management unit may be configured to manage the permission of the user and activate corresponding functions in the quality control layer according to the permission of the user.

Specifically, the user management unit may be configured to determine whether the target function complies with a permission of the user in response to a trigger operation of a user on a target function in a plurality of functions, and activate the target function in a case that the permission of the user is complied.

The plurality of functions are activated to respectively perform the following operations:
configuring parameters of the plurality of first devices, debugging a process device of the production line, performing statistics on the quality inspection results, updating the defect detection model, associating a configuration parameter of the target production line to an associated production line, and correcting erroneously-inspected to-be-inspected objects.

Specifically, in some examples, operation permissions for execution in the quality control system include the following categories:

Quality inspection: including the initiation of the quality inspection on a production line, the setting (corresponding to configuring parameters of a plurality of first devices) of configuration parameters (configuration parameters of the first devices) required during the quality inspection, the verification of a quality inspection result (corresponding to error correction of an erroneously-inspected to-be-inspected object), the statistics, analysis, and query of the quality inspection result, and the migration of the quality inspection (corresponding to associating configuration parameters of a target production line to an associated production line).

Infrastructure layer management: including access, deployment, state monitoring, running, network configuration, and security protection of the first devices (including a gateway, an industrial control server, a quality inspection server, and a data server) in the infrastructure layer.

Production line regulation: including statistical analysis on the quality inspection result, regulation of the process devices (including the second device and the server) on the production line, and adjustment of the configuration parameters of the second device.

Algorithm control: including the deployment, update (corresponding to updating the defect detection model), and construction of the defect detection model, configuration of model parameters, and construction of a training sample used by the defect detection model (involving data labeling).

It should be noted that a function activated by an operation permission included in each category herein is referred to as the above-mentioned target function. The permission for operation by an ordinary login user and the permission for operation by an administrator user may be different, or overlap with each other.

For example, the operation permission performed by the ordinary login user in the quality inspection category may include: setting configuration parameters (configuration parameters of the second device) required during the quality inspection and verifying the quality inspection results. Furthermore, the operation permission performed by the administrator user in the quality inspection category may include: the initiation of the quality inspection on the production line, and the statistics, analysis, and query of the quality inspection results. Alternatively, in some cases, the operation permission performed by the ordinary login user in the quality inspection category may include: the initiation of the quality inspection on the production line, the setting of configuration parameters (configuration parameters of the second device) required in the quality inspection, and the statistics and analysis of the quality inspection results. Furthermore, in addition to the above-mentioned operation permission (operation permission of the ordinary login user), the operation permission performed by the administrator user in the quality inspection category may also include: verification of the quality inspection results and query of statistical results of the quality inspection.

For example, the operation permission performed by the ordinary login user in the infrastructure layer management category may include: the state monitoring, running, and network configuration of the first devices (including a gateway, an industrial control server, a quality inspection server, and a data server) in the infrastructure layer. The administrator user may have access, security protection, and the like of devices in addition to the above-mentioned operation permission.

For example, the ordinary login user cannot perform the operation permission of the production line regulation category, while the administrator user may have the operation permission of the production line regulation category. The ordinary login user cannot have the operation permission of the algorithm control category, while the administrator user can have the operation permission of the algorithm control category. Alternatively, the ordinary login user only has a partial control permission in the operation permission of the product line regulation category, such as the adjustment of the configuration parameters of the second device. The ordinary login user also only has a partial operation permission in the algorithm control category, such as construction of a training sample used by the defect detection model (involving data labeling).

Certainly, since the technical threshold for model deployment is reduced in the embodiments of the present disclosure, the ordinary login user can also simply perform the deployment, update, and construction of the defect detection model, the configuration of model parameters, and the construction of the training sample used by the defect detection model (involving data labeling). Therefore, the administrator user authorizes the ordinary login user to obtain the above-mentioned operation permission.

FIGS. 2b-2d are schematic interface diagrams showing that a user management unit manages the user information. As shown in FIG. 2b, either an ordinary login user or an administrator user may include a user name, a user type, a user ID, a password, a registration date, remark information, and the like. The administrator user may edit user information of each ordinary login user and change a password. FIG. 2c shows a schematic interface diagram of operation information generated by a user in an operation, including a user name, a log type, log details, an event occurrence server ID, and the like for counting operations performed by the users and servers where the operations are located when the users are different. FIG. 2d shows the statistics on the quality inspection of each user by the user management unit, including: user ID, number of images, number of NGs, and manual retest time, for recording the quality inspection performed by the user on the production line.

It should be noted that FIGS. 2b-2d are merely exemplary and are not specifically limited herein.

As described above, the permission of a user to a target function in a plurality of functions may be granted by an administrator user with the highest permission among the administrator users.

The user management unit may create a user and issue a permission according to an administrator, respond to an operation that a user on a production line registers an industrial control device on the production line, and register the industrial control device into a management system. After configuring the initialization connection between the industrial control device and the server, the user enters and debugs production material information, parameters of the industrial control device, and algorithm parameters, and then starts the detection. This process needs to be performed according to the permission.

In this way, the quality control process may be disassembled into a plurality of sub-functions, whereby a user with a corresponding technical level can use the corresponding sub-functions, thereby achieving the purpose of managing and controlling the quality of a production line according to the technical level of workers, and improving the management and control level and efficiency.

In some embodiments, the data generated in the quality inspection may include at least one of: a quality inspection result and an image acquired in the quality inspection.

Accordingly, the processing of the data generated in the quality inspection includes at least one of: storage, statistics, retrieval, labeling, and query.

In this embodiment, the storage may refer to the storage of the quality inspection results and the images. The statistics may refer to the statistics of the quality inspection results. The retrieval may include the retrieval of a quality inspection result of a certain to-be-inspected object, the retrieval of a quality inspection result of a certain detection time period, and the like.

As shown in FIG. 2, in one example, the information management module may further include a data management unit, a device management unit, and a data analysis unit in addition to the above-mentioned user management unit.

The data management unit is configured to perform data statistics, data retrieval, data storage, data labeling, and multi-terminal query. That is, the above-mentioned processing of the data generated in the quality inspection may be data statistics, data retrieval, data storage, data labeling, and multi-terminal query.

The device management unit is configured to perform functions such as state monitoring, configuration policy, policy issuing, and production line regulation. The configuration policy and the policy issuing may involve that: different servers may configure different defect detection models, so as to perform the quality inspection on different types of defects, or roughly inspect and finely inspect the to-be-inspected objects. The production line regulation may be in communication with the industrial control server to regulate the process parameters of the plurality of second devices on the production line.

The state monitoring may be monitoring the states of the gateway and the server, and may, certainly, include monitoring the states of the second devices on the production line subsequently. The monitoring the states of the gateway and the server may include that: whether the network connection is secure, whether the network connection is normal, whether the communication between servers is secure, and the like.

The data analysis unit may be configured to perform statistical analysis and data docking of the quality inspection results, and the data docking may refer to: docking the quality inspection results of the same to-be-inspected object on different production lines.

FIG. 2a is a schematic diagram of a list showing that a device management unit manages servers. As shown in FIG. 2a, it includes the setting of a server type, such as a fine inspection server or a rough inspection server, and includes a server code, a server online state, an IP address, the number of to-be-inspected objects subjected to the quality inspection, and the like.

As shown in FIG. 2, in one example, the detection module may include an industrial control device configuration unit, an algorithm configuration unit, a material configuration unit, a device monitoring unit, and a quality inspection unit.

The industrial control device configuration unit may be configured to perform debugging of the industrial control device, configuration of device parameters, protocol parsing, and device access. The industrial control device may include a first device and a second device. The configuration of the device parameters may refer to the configuration of parameters of the first device and the second device.

The algorithm configuration unit may be configured to perform real machine debugging and parameter configuration, and the parameter configuration herein may refer to the configuration of parameters of a model.

The material configuration unit may be configured to perform product parameter entry and configuration of a quality inspection policy. The product parameter may refer to the parameter of a to-be-inspected object, such as the size of the to-be-inspected object and a region where the quality inspection needs to be performed. The configuration of the quality inspection policy may refer to performing batch quality inspection on the to-be-inspected objects, determining whether it is fine inspection or rough inspection, and the like.

The quality inspection unit is configured to perform defect detection, real-time monitoring of the quality inspection, verification of the quality inspection results, and statistics of the quality inspection results of to-be-detected regions of the to-be-inspected objects.

The device monitoring unit is configured to monitor the working condition of each device, and may perform a linkage alarm on the failed device. The linkage alarm herein may refer to: performing an alarm on modules associated with the failed device. If the failed device is a camera for image acquisition, the linkage alarm may be: alarm in the quality inspection unit, alarm in the industrial control device configuration unit, and the like.

As shown in FIG. 2, the model management module may also be referred to as an AI development platform, which may be configured to support data labeling, model development, model training, and model publishing.

The data labeling may refer to re-labeling a to-be-inspected object which is erroneously inspected or missed after quality inspection. The erroneous inspection represents that the defect detection model cannot accurately detect the to-be-inspected object. Therefore, an image of the to-be-inspected object may be referred to as a negative sample or a difficult sample, and the image may be re-labeled and used as a training sample to update the defect detection model.

The model development may include the construction of the defect detection model, the update of the defect detection model, and the migration of the defect detection model described in the subsequent embodiments, so as to obtain a migration model adapted to an associated production line. A defect of a to-be-inspected object to be detected by the associated production line is the same as or similar to the type of a defect of a to-be-inspected object to be detected by a target production line.

The model publishing may refer to the deployment of the defect detection model after the defect detection model is obtained, for example, deploying into a server. As described above, different servers may deploy defect detection models for different defect types, and different servers may also deploy defect detection models with different detection precisions.

In a specific example, the above-mentioned modules related to the quality inspection in the quality control system is analyzed and described. FIG. 2e shows a schematic diagram of work division of modules related to the quality inspection in a quality control system. As shown in FIG. 2e, generally, an automatic training, a quality inspection client, and a quality inspection server are included. The quality inspection server is the above-mentioned server configured with the defect detection model. The automatic training is the above-mentioned model management module. The quality inspection client is the above-mentioned detection module. The quality inspection server is configured to perform the quality inspection.

The automatic training includes: functions such as data labeling, automatic training, real machine debugging of the production line, and service publishing. The service publishing is model publishing, and these functions will be explained in detail in Embodiment 2.

Specifically, the automatic training may trigger at least one trigger control through the model management module in response to a triggered model construction function. Different trigger controls are used for triggering different configuration windows in the model construction process. Then, a plurality of configuration options are outputted in different configuration windows for selection by a user. Different configuration options correspond to different preset configuration parameters, and the preset configuration parameters are used for providing parameters, such as an operating environment, a training configuration, and an algorithm, for a training model. In this way, the user can automatically train the model through the model management module.

At the same time, a new labeling data set, namely, a second data set, may also be created by the model management module in response to a triggered model update function, and then a plurality of configuration options for model update are outputted in different configuration windows for selection by a user. Different configuration options correspond to different preset configuration parameters, and the preset configuration parameters are used for providing parameters, such as an operating environment, a training configuration, and an algorithm, for the training model, whereby the defect detection model can be automatically updated.

Certainly, the model management module may be configured to provide the associated production line with an update of a model required thereby when it is required to migrate the defect detection model on the target production line to the associated production line. For example, a target data set corresponding to the associated production line is obtained, and in response to a triggered model migration function, the defect detection model on the target production line may be updated by using the target data set to obtain a migration model. When the migration model is obtained, a plurality of configuration options for model update may also be outputted in different configuration windows correspondingly for selection by a user.

Certainly, in still other scenarios, the automatic training may be used in other scenarios different from the production lines in the field of industrial manufacturing. For example, for an intelligent bank or the field of an intelligent park or intelligent traffic, the intelligent bank has many service lines, and the intelligent park and intelligent traffic include a plurality of traffic lines. If each line and service line are analogized as a production line and a corresponding service category on each line and service line is a to-be-inspected object on the production line, the method of the present disclosure may be used to acquire information of the object on each line and service line, and to take the acquired information as a training sample of the “production line”, thereby obtaining an AI model of a class of objects under this production line.

For example, by using the automatic training of the present disclosure with respect to passenger flow statistics for each service line in the intelligent bank, park hunting in the field of the intelligent park or intelligent traffic, and the like, it is also possible to solve the above-mentioned technical problems of less training samples, models to be updated or added, and the like in these scenarios.

Similarly, the migration of an AI model may be performed from line to line, and the migration of an AI model may be performed from service line to service line. During the migration process, only a small number of training samples on the associated production line are needed, and the problem of difficulty in obtaining samples can also be solved.

The quality inspection client includes: manual re-inspection, detection machine initialization, configuration of production material information, configuration of industrial control device parameters (namely, configuration parameters), starting quality inspection, data visualization, and the like. The production material information refers to information of the to-be-inspected object on the target production line, and this function will also be explained in detail in Embodiment 2 where relevant to the window interface of quality inspection.

The data server includes: the functions of personnel permission issuing, detector policy, data management, and data analysis, which are explained in detail in Embodiment 2.

It should be noted that data labeled by the manual re-inspection in the quality inspection client may be fed back to the automatic training as a data set (second data set) for model update. The model published by the service publishing may be used for the quality inspection.

However, information generated by the quality inspection client in the above-mentioned process is stored in the server, and the data server performs data management.

With the quality management system of the present disclosure, it is possible to implement into a manufacturing factory, make a close association with a front-end production line, use the hardware support provided by the infrastructure layer to perform the quality inspection on the to-be-inspected objects produced on each production line through the quality control layer, and regulate the process device of the production line according to the quality inspection result. In addition, different modules, such as the information management module, the detection module, and the model management module, may be arranged to achieve the separate management of different tasks in the process of quality inspection control. At the same time, the core functions of data labeling, model training, and model publishing in the development of a quality inspection scenario model are integrated to reduce the technical threshold, whereby the departments with weak AI technology accumulation use AI technology, thereby improving the research and development efficiency.

A quality control method for a production line of the present disclosure is described in Embodiment 2 in conjunction with the manufacturing platform and the quality control system described in Embodiment 1.

### Embodiment 2

FIG. 3 is a flow chart showing the steps of a quality control method for a production line according to the present disclosure. As shown in FIG. 3, the method may be applied to a quality control system, and more specifically may be applied to a quality inspection module of the quality control system. The method may specifically include the following steps:

Step S301: in response to triggering of a first preset condition, performing quality inspection on a plurality of to-be-inspected objects produced on a target production line.

In this embodiment, the first preset condition may be triggered based on triggering a preset operation on an interface in the quality control system, for example, a single click, a double click, and the like on a quality inspection button on the interface, indicating that the first preset condition is triggered, whereby the quality inspection may be started on the plurality of to-be-inspected objects produced on the target production line based on the trigger.

The quality inspection includes: performing at least one image acquisition on the to-be-inspected objects produced by the target production line, and inputting at least one acquired image into a defect detection model, so as to perform the quality inspection on the to-be-inspected objects. The quality inspection may be a quality inspection or a periodic quality inspection, which is not particularly limited herein.

The to-be-inspected objects may refer to devices, appliances, textiles, and the like produced on the target production line, which are not limited herein.

Specifically, the process of quality inspection may be: for each to-be-inspected object produced, performing at least one image acquisition on the to-be-inspected object, and inputting at least one acquired image into a defect detection model for defect detection.

The performing at least one image acquisition on the to-be-inspected object may refer to: performing at least one image acquisition on a region to be detected in the to-be-inspected object, where the region to be detected may be determined according to a target of quality inspection. For example, the target production line is a production line for cutting a display substrate, and the region to be detected may be an edge region of the cut display substrate. For example, if the target production line is used for film deposition on the display substrate, the region to be detected may be a film deposition region.

The number of image acquisitions may be determined according to the precision requirements of the quality inspection, and each image acquisition may obtain an image of a to-be-detected region. In different times of the image acquisitions, the image acquisition may be performed for different positions in the to-be-detected region, or image acquisition with different resolutions may be performed for the same position in the to-be-detected region.

The image acquisition may be performed according to pre-configured parameters. The pre-configured configuration parameters may include an acquisition frequency and an acquisition resolution of the image acquisition. In some cases, image acquisition needs to be performed on different positions of the to-be-detected region during the movement, and the pre-configured configuration parameters may also include a movement rate of the image acquisition. The movement rate may be a movement rate of the image acquisition apparatus when the to-be-inspected object is stationary and the image acquisition apparatus is moving, or may be a movement rate of the to-be-inspected object when the image acquisition apparatus is stationary and the to-be-inspected object is moving. For example, the image acquisition apparatus is moved relative to the to-be-detected region of the to-be-inspected object. In this case, more image data may be obtained, or partial images stitched into a complete image may be obtained, or a plurality of separate samples may be used for confirming different defect regions.

The defect detection model may be pre-configured into the quality inspection server according to the quality inspection requirements of the target production line. As described in the above-mentioned embodiment, different quality inspection servers may be configured with defect detection models required by different production lines, or different quality inspection servers may be configured with defect detection models with different precisions. When performing the quality inspection, an image acquired by the image acquisition apparatus may be sent to the quality inspection server, and the quality inspection server invokes the defect detection model to perform defect detection on the image, and outputs a defect detection result to a control object associated with the target production line.

The quality inspection result of the to-be-inspected object may be determined according to the defect detection results respectively corresponding to a plurality of images of the to-be-inspected object. Since different images may reflect different positions in the to-be-detected region, the defect detection results corresponding to different images may reflect the defect detection results at different positions. Therefore, the quality inspection result of the to-be-inspected object may be determined by integrating the defect detection results at different positions.

In some examples, it may be determined that the to-be-inspected object passes the quality inspection when the defect detection results of all the images of the to-be-inspected object indicate no defect, otherwise, the to-be-inspected object does not pass the quality inspection. In still other examples, it is determined that the to-be-inspected object passes the quality inspection when the defect detection results of more than a preset number of images of the to-be-inspected object indicate no defect, and it is determined that the to-be-inspected object does not pass the quality inspection if the number of images with no defect is less than the preset number.

In other examples, at least one critical position may also be marked in the to-be-detected region. The critical position may refer to a position where the performance of the to-be-inspected object has a significant effect. Further, when the defect detection result at the critical position passes the quality inspection, it may be determined that the to-be-inspected object passes the quality inspection, and when the defect detection result at the critical position does not pass the quality inspection, even if other positions have no defects, it may be determined that the to-be-inspected object has failed the quality inspection. Starting from this example, in the process of image acquisition, the acquisition frequency and resolution of the image acquisition at a critical position may be different from the acquisition frequency and resolution of the image acquisition at other positions. Specifically, the acquisition frequency of the image acquisition at the critical position may be higher than the acquisition frequency of the image acquisition at other positions, or the resolution of the image acquisition at the critical position may be different from the resolution of the image acquisition at other positions. Alternatively, the acquisition frequency and resolution of the image acquisition at the critical position are higher than those at other positions, so as to improve the pertinence of defect detection and help to improve the efficiency of defect detection.

Certainly, the above-mentioned critical position may be calibrated by setting configuration parameters, and the implementation process of the configuration parameters may be described in connection with the following embodiments. In the example of determining the quality inspection result based on the defect detection result of the critical position, an image acquisition mode in which the image acquisition apparatus is stationary and the to-be-inspected object moves may be used. In this way, during the movement of the to-be-inspected object, when the critical position moves into an imaging range of the image acquisition apparatus, the critical position may be detected by the sensor, and then a trigger instruction is sent to the image acquisition apparatus so as to trigger the image acquisition apparatus to perform image acquisition at a high resolution and/or a high acquisition frequency at the critical position according to the corresponding configuration parameter at the critical position. When the critical position moves outside the imaging range of the image acquisition apparatus, the critical position may also be detected by the sensor, and then a trigger instruction is sent to the image acquisition apparatus, so as to trigger the image acquisition apparatus to perform image acquisition at a low resolution and/or a low acquisition frequency on the remaining positions according to the configuration parameters corresponding to the positions outside the critical position.

In some examples, the quality inspection result obtained by the quality inspection server and the image targeted by the quality inspection may all be sent to the data server, and the data server may store the results of defect detection and the results of quality inspection on a plurality of images of the same to-be-inspected object, so as to subsequently perform statistics and query on the quality inspection results of the to-be-inspected objects of the target production line.

Step S302: Feeding back a result of the quality inspection to a control object associated with the target production line, where the control object is used for controlling a process flow of the target production line.

In the process of performing the quality inspection on the to-be-inspected objects on the target production line, the quality inspection result may be fed back to the control object each time the quality inspection of a preset number of the to-be-inspected objects is completed; or the quality inspection result of the quality inspection of the to-be-inspected object completed in the current time period may be fed back to the control object at preset time intervals; or, each time the quality inspection of a to-be-inspected object is completed, the quality inspection result of the to-be-inspected object is fed back to the control object.

The control object is a control object associated with the target production line. In practice, the control object may be a client of the target production line, and the client may be understood to be an industrial control system of the target production line. As mentioned in the foregoing background, the industrial control system may be configured to control a process flow of the target production line and control the process device on the target production line. For example, the industrial control system may be a production information management system.

The control object may also be a device management unit in the information management module in the quality control system. In particular, as shown in FIG. 2, the device management unit may also be in communication with a process device (the above-mentioned second device) on the target production line so as to configure parameters of the process device. In this embodiment, the device management unit may be a window interface for providing regulation in the quality control system, and a user may log in to the quality control system via an account so as to enter a window interface related to the regulation (production line regulation), a quality inspection result may be displayed according to a user operation, and the regulation may be triggered according to the user operation.

In some embodiments, the control object may perform statistics and analysis on the quality inspection results of the to-be-inspected objects, and determine a time period during which the to-be-inspected objects which has failed the quality inspection are produced, or may determine the distribution of defect positions occurring in the to-be-inspected objects which has failed the quality inspection, or the time period and the distribution may be determined at the same time. Then the statistical results of the time period and the statistical results of the distribution of the defect positions may be displayed through a chart, so as to assist a user to intuitively understand the quality status of the to-be-inspected objects produced on the target production line, and thus perform targeted debugging.

Step S303: In response to a second preset condition triggered on the control object, regulating the target production line based on a quality inspection result of at least one to-be-inspected object.

In this embodiment, a user can directly operate on the control object to facilitate the triggering of the second preset condition. The second preset condition may be triggered by the user clicking or double-clicking a “debugging” key on the control object, such as the above-mentioned regulated window interface. Therefore, the system may automatically regulate the target production line according to the quality inspection result of the to-be-inspected object.

For example, in a specific solution, the trigger of the key may be regulated by a front end of a browser, an acquired image (an image acquired for a to-be-inspected object) stored in a database may be invoked in the background through a preset code or a system library file or a monitoring function, and the acquired image is transmitted to the defect detection model to output a result. In this case, the defect detection model may extract image features through a preset code, and then output the image features as quality inspection results. Certainly, in some examples, a defect region image with a defect may also be outputted. Furthermore, the above-mentioned information (quality inspection result and defect region image) is sorted out and outputted to the front-end browser for presentation. It will be understood that after the AI model (defect detection model) outputs the required information, the quality inspection result may be re-processed through an algorithm or a preset code, such as statistical classification, and the information obtained after the re-processing is presented to the user, whereby the user can intuitively and carefully observe the quality inspection result of the to-be-inspected object when a front-end regulation key is triggered.

The quality inspection results based on which the system regulates may originate from a batch of to-be-inspected objects. Certainly, in some cases, the results may also originate from a certain to-be-inspected object. It is preferable to regulate the target production line based on the quality inspection results of a batch of to-be-inspected objects.

Specifically, when the target production line is regulated according to the quality inspection results, as described above, the quality inspection results may be statistically analyzed according to the time period of production and the distribution of the defect positions. In general, when the quality inspection results are statistically analyzed according to the time period of production, it may be determined which time period of production has more to-be-inspected objects which have failed the quality inspection, and which time period of production has less to-be-inspected objects which have failed the quality inspection, so that it may be determined that the target production line is liable to have a failure in the process flow at some time period, thereby regulating the process flow at the time period accordingly. When performing statistical analysis according to the distribution of the defect positions, it may be determined which position of the to-be-inspected object has more defects and which position has less defects. Generally, the defect position is related to the production of the to-be-inspected object in the target production line. For example, when cutting the display substrate, if the statistical analysis result of the defect position shows that a greater number of the to-be-inspected objects which have failed the defect detection occur at an upper left corner of the display substrate, it indicating that a cutting process device corresponding to the upper left corner needs to be debugged.

Thus, the target production line may be regulated according to the statistical analysis result of the time period of production of the to-be-inspected objects and/or the distribution of the defect positions. When regulating, the process flow corresponding to the time period of production, when the number of the to-be-inspected objects which have failed the quality inspection is greater, may be regulated according to the statistical analysis result, and the process flow corresponding to the position, where the number of the to-be-inspected objects which have failed the defect detection is greater, may be regulated, so that the quality inspection of the to-be-inspected objects may be fed back to the target production line to regulate the target production line. Therefore, the target production line may be continuously maintained at a higher quality process level. As a result, the quality level of the objects produced thereby is improved, thereby improving the quality control level of the target production line.

It should be noted that the regulation referred to in this embodiment may include adjustment and control. The adjustment is adjustment on the process flow, and may include improvement on the process flow and adjustment on the working parameters of the process device. The control may refer to: controlling the target production line to produce the to-be-inspected objects based on the adjusted working parameters and the improved process flow.

With the technical solution of the present disclosure, on the one hand, the quality inspection may be started on the to-be-inspected objects on the target production line in response to the triggered quality inspection function, and a result of the quality inspection may be fed back to a control object associated with the target production line. In response to the debugging function triggered on the control object, the target production line is regulated based on the quality inspection result of at least one to-be-inspected object, whereby the quality inspection on the to-be-inspected object in the present disclosure may be deeply implemented into a production line for producing the to-be-inspected objects, so as to regulate the process flow and the like of the production line in combination with the quality inspection condition of the to-be-inspected objects. Therefore, the yield problem of the to-be-inspected objects can be solved from the source of producing the to-be-inspected objects, such as process parameters and process devices, and the production cost consumed due to the abandonment of the to-be-inspected objects with poor quality can be reduced. On the other hand, since the target production line may be regulated according to the statistical analysis results of the quality inspection results in the time period of production and the defect position, the target production line may be regulated in a targeted manner and the regulation efficiency can be improved.

In order to make the quality inspection of the AI-based technology implemented into the production line to guide the quality control of the production line, the above-mentioned quality inspection may be triggered automatically based on the operation of the production line, so as to reduce the expenditure of manpower cost, or may be triggered manually by a user, so as to facilitate the user to control the progress of the quality inspection of the production line.

In order to fully explain the quality control method in subsequent embodiments, an interface of a quality control system operated by this method is described, and specifically reference may be made to FIG. 14:

A system interface may be included in the quality control system, and a plurality of function buttons may be distributed on the system interface, such as a quality inspection function button and a regulation function button. By clicking or double-clicking the quality inspection button, a window interface of the quality inspection may be entered, and by clicking or double-clicking the regulation button, a window interface of the regulation may be entered. In the window interface of the quality inspection, a user can configure parameters based on which when the quality inspection is performed, trigger the quality inspection, and adjust the progress of the quality inspection in real time. In the window interface of the regulation, the quality inspection result of the to-be-inspected object may be displayed, and the statistical analysis result of the quality inspection result may be displayed, and the regulation of the target production line may be triggered.

In a specific implementation, the infrastructure layer may further include a display server. The display server may refer to a web server providing page display for the quality control system of the present disclosure, which may be in communication with a quality inspection server, a data server, a training server, and an industrial control server, and is configured to transmit instruction information generated in response to the trigger in a front-end browser page to the quality inspection server, the data server, the training server, and the industrial control server, so as to obtain corresponding information, and present the sorted information on the front-end browser page.

The system interface, the window interface of the quality inspection, and the window interface of the regulation do not conflict with the architecture of the quality control system shown in FIG. 2, and the system interface, the window interface of the quality inspection, and the window interface of the regulation may be reasonably arranged according to the architecture of the control system so as to facilitate the use of users.

Accordingly, in some examples, the first preset condition may include: starting operation of the target production line, and/or a quality inspection function triggered on a preset interface.

In some embodiments, it may be determined that the first preset condition is triggered when the target production line starts running to produce a to-be-inspected object, and thus the quality inspection of the to-be-inspected object may be started based on the running of the target production line. In still other embodiments, a quality inspection key may be provided on a preset interface to trigger the first preset condition by clicking or double-clicking on the quality inspection key, thereby performing quality inspection. The quality inspection key corresponds to the quality inspection function of the quality control system.

The preset interface may be a system interface of the quality control system, and the system interface may be configured with: a quality inspection function button and a regulation function button. A user can log in to the system via an account, thereby triggering the quality inspection function button to enter the window interface of the quality inspection, and triggering the quality inspection key in the window interface.

Accordingly, as described above, the triggering of the above-mentioned regulation may be regulation performed automatically based on the result of the quality inspection, so as to improve the automation level of the quality control of the production line, or regulation performed based on the manual triggering of the user, so as to facilitate the user to perform manual debugging on the production line according to the result of quality inspection.

In some examples, the second preset condition includes: the number of the to-be-inspected objects that fail the quality inspection being greater than or equal to a preset number, and/or preset operations triggered on the control object.

In this example, if the number of the to-be-inspected objects which have failed the quality inspection is greater than or equal to the preset number, the regulation of the target production line may be triggered. In this case, it indicates that there are more to-be-inspected objects which have failed the quality inspection, and the target production line needs to be regulated. As described above, the target production line may be regulated according to the statistical analysis result of the quality inspection result of the to-be-inspected objects passing the quality inspection. For example, the target production line may be regulated according to the time period of production of the to-be-inspected objects and the distribution of the defect positions.

Certainly, in still another example, the regulation of the target production line may be triggered depending on a preset operation of a user on the control object. The preset operation may refer to a single click or a double click of the regulation key on the control object. The control object may be understood as a window interface of the regulation displayed when the regulation function button is triggered, the fed-back quality inspection result of the to-be-inspected object may be displayed in the window interface of the regulation, and the statistical analysis result of the fed-back quality inspection result of the to-be-inspected object may also be displayed. The user can thus trigger the preset operation on the window interface of the regulation (control object) based on the statistical analysis result.

As described in Embodiment 1, the detection module may include an industrial control device configuration unit, an algorithm configuration unit, a material configuration unit, and the like. These units may be configured to perform parameter configuration and debugging on the industrial control device, and perform parameter configuration on an algorithm of a model. Therefore, in some embodiments, when the AI technology is implemented to the production line, configuration may be performed first, and subsequent quality inspection may be performed based on the configured parameters.

In a specific implementation, before step S301, a first configuration interface may be displayed in response to a triggered quality inspection configuration function, and configuration parameters respectively inputted through the first configuration item and the second configuration item are received.

The first configuration interface includes a first configuration item of a device for the quality inspection and a second configuration item of the defect detection model.

Accordingly, when performing the quality inspection on a plurality of to-be-inspected objects produced on a target production line, the quality inspection may be performed on the plurality of to-be-inspected objects produced on the target production line based on the configuration parameters.

In this embodiment, the quality inspection configuration function may be located in a window interface of the quality inspection. Specifically, a function key may be arranged for triggering the quality inspection configuration function so as to display the first configuration interface. The function key may be related to the detection module in FIG. 2. For example, as shown in FIG. 14, a quality inspection configuration key may be included in the window interface of the quality inspection and may be configured to trigger the quality inspection configuration function. The quality inspection configuration function thereof may have the functions included in the industrial control device configuration unit, the algorithm configuration unit, and the material configuration unit in the detection module in FIG. 2. Certainly, the quality inspection configuration key is triggered, and the configuration items corresponding to the above-mentioned various units may be correspondingly provided in the window interface entered, so as to complete the setting of various parameters.

The first configuration interface may include a first configuration item and a second configuration item. The first configuration item may be used for parameter configuration of a device for the quality inspection, and the second configuration item may be used for parameter configuration of the defect detection model.

There may be one or more devices for the quality inspection, which may include devices required in the quality inspection process, such as an image acquisition device and a controller related to the image acquisition device. In practice, configuration parameters of the device for the quality inspection need to be inputted through the first configuration item. For example, in a specific implementation, the inputted configuration parameters may be acquired in the background through the trigger of the quality inspection configuration key at the front end of the browser via a preset code or a system library file or a monitoring function, and then sent to a background server, such as the industrial control server in the infrastructure layer, through a message queue in the form of a data packet, so as to realize the parsing of the data instruction information by the industrial control server and the control of a device or program to be controlled.

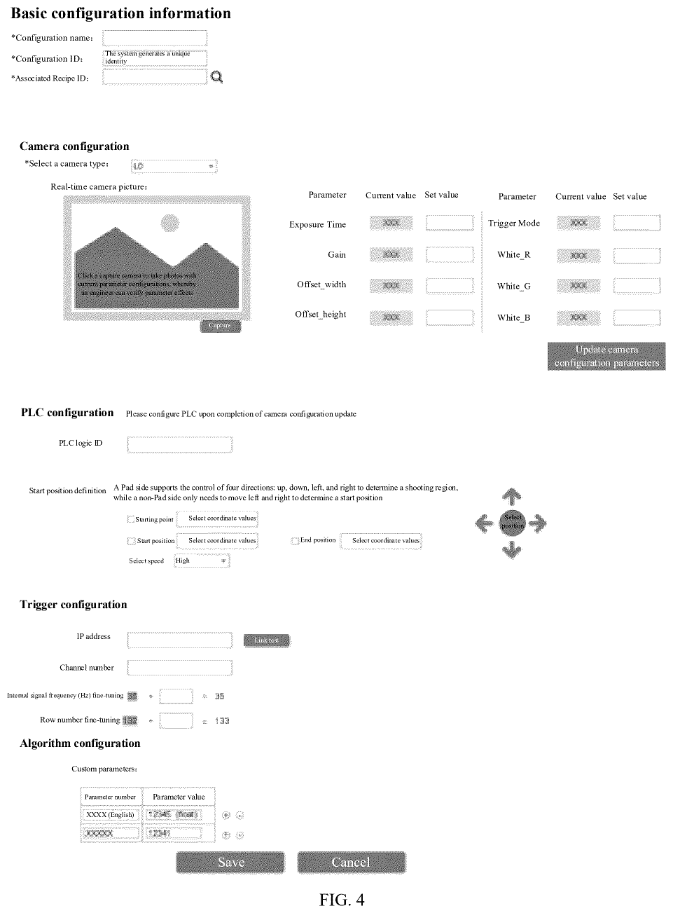

Specifically, the device for the quality inspection includes an image acquisition device and a controller. FIG. 4 shows a schematic interface diagram of a first configuration interface. As shown in FIG. 4, the first configuration item may include a plurality of sub-configuration items, and different sub-configuration items are used for configuring different configuration parameters. As shown in FIG. 4, a sub-configuration item of a camera (image acquisition apparatus) and sub-configuration items of a PLC (controller) and a trigger are included.

In some embodiments, the device for the quality inspection includes an image acquisition apparatus and a controller, and the first configuration item may be used for inputting working parameters respectively corresponding to the image acquisition apparatus and the controller.

The working parameter corresponding to the image acquisition apparatus includes an acquisition frequency and/or an acquisition resolution, and the working parameter corresponding to the controller includes a start position, an end position, and a movement rate. The controller is configured to control the movement of the image acquisition apparatus, or to control the movement of the to-be-inspected object, or to respectively control the movement of the image acquisition apparatus and the to-be-inspected object. The movement rate may be as described in the aforementioned relevance.

The image acquisition apparatus may include a camera, and the controller may be a PLC. As shown in FIG. 4, the working parameter to be configured for the camera may include: an acquisition frequency, an acquisition resolution, and the like. The working parameter to be configured for the controller may include: a start position, an end position, a movement speed, and the like. The controller needs to control the start position, the end position, and the movement speed of the image acquisition. The start position refers to: a start position at which the image acquisition of the to-be-inspected object begins. The end position refers to a start position at which the image acquisition of the to-be-inspected object ends. The movement rate refers to a movement rate of the to-be-inspected object moving from the start position to the end position, or refers to a movement rate of the image acquisition apparatus moving from the start position to the end position.

In this implementation, since the start position, the end position, and the movement speed are configured, instruction information may be directly formed by defining the position on the configuration interface and sent to the controller, thereby enabling more convenient and fast instruction information formation by a visual operation button.

The working parameter to be configured for the trigger may include: an IP address, a channel number, a frequency setting, and the like. The trigger is configured to detect the arrival of a to-be-inspected object, and send a trigger signal to the corresponding controller so as to instruct the controller to control the camera or the to-be-inspected object to move for the image acquisition. The trigger and the controller may be communicatively connected via a network, and thus parameters such as an IP address, a channel number and a frequency need to be configured.

The first configuration item may, certainly, include a sub-configuration item of basic information. The sub-configuration item of the basic information may include the name of an associated target production line, a configuration description, and the like.

In still other embodiments, the second configuration item may be used for inputting a threshold parameter corresponding to the defect detection model and/or for inputting a working parameter of a server configured with the defect detection model.

As shown in FIG. 4, the second configuration item is used for configuring a parameter of the defect detection model. The parameter of the defect detection model may be a parameter for controlling a defect passing rate of the model to the to-be-inspected object, such as a threshold parameter. Therefore, hyperparameters and operating environment parameters in the model may be configured by a professional instead of being configured in advance, and thus the technical threshold for a technician to use AI for quality inspection on the to-be-inspected object can be reduced.

The server configured with the defect detection model is the above-mentioned quality inspection server. The working parameter of the quality inspection server may refer to hardware and software configurations of the quality inspection server for defect detection, or an ID configuration of the quality inspection server, so as to select the quality inspection server adapted to the production condition of the to-be-inspected object at present, such as a first quality inspection server (corresponding to rough inspection) or a second quality inspection server (corresponding to fine inspection).

The user can complete the configuration of the device for the quality inspection and the configuration of the defect detection model by inputting the corresponding configuration parameters in the first configuration item and the second configuration item on the first configuration interface. In this case, the quality control system may associate the configuration parameters configured by the user into the target production line so as to perform the quality inspection directly based on the configuration parameters when the first preset condition of the target production line is triggered.

Specifically, when the quality inspection is performed on a plurality of to-be-inspected objects produced on the target production line based on configuration parameters, image acquisition may be performed on the to-be-inspected objects based on the configuration parameter of the device for the quality inspection, and the defect detection model may perform defect detection on images of the to-be-inspected objects based on the configuration parameter of the defect detection model, such as a parameter based on a defect passing rate. A probability threshold characterizing a defect probability is adjusted so as to regulate the precision and passing rate of the quality inspection.

Certainly, a user can previously use a sub-function such as a test tool and real machine debugging shown in FIG. 2 to preset configuration parameters, that is to say, enter a real machine debugging interface by using the test tool and the real machine debugging. A first configuration item and a second configuration item are also displayed on the interface, but the first configuration item and the second configuration item are used for inputting configuration parameters used by the user for testing.

For example, the user inputs the configuration parameter of the device for the quality inspection and the configuration parameter of the defect detection model, which can acquire information from the test device by using the device for the quality inspection according to the configuration parameter inputted by the first configuration item, and detect an acquired image of the test device according to the configuration parameter inputted by the first configuration item. The image of the test device and the detection result may be fed back to the real machine debugging interface, whereby the user can observe the image acquisition effect and the detection result, thereby setting the configuration parameters in the first configuration item and the second configuration item to obtain adapted configuration parameters. The adapted configuration parameters may be automatically migrated to the first configuration interface and automatically inputted to the first configuration item and the second configuration item in the first configuration interface when the quality inspection configuration function is triggered, and may thus be directly used without requiring a worker with a low technical threshold to input corresponding configuration parameters. The initial device is a device conforming in shape and size to the to-be-inspected object on the target production line.

In still other embodiments, the quality inspection may be a real-time quality inspection, which may refer to: while the target production line produces a to-be-inspected object, the quality inspection is also performed on the produced to-be-inspected object. In this case, in the process of real-time quality inspection, according to the efficiency of the quality inspection and the quality inspection results, the configuration parameters may be adjusted and updated timely through the window interface of the quality inspection so as to adapt to the production condition of the to-be-inspected object in the target production line.

In a specific implementation, a second configuration interface may be displayed in response to a triggered quality inspection debugging function. A statistical result about statistics on the quality inspection results of the to-be-inspected objects subjected to the quality inspection is displayed on the second configuration interface, and a configuration parameter modified from a current configuration parameter of the target configuration item is recorded.

The second configuration interface includes a target configuration item. The target configuration item includes a first configuration item of a device for the quality inspection and/or a second configuration item of the defect detection model.

Accordingly, when performing the quality inspection on a plurality of to-be-inspected objects produced on a target production line, the quality inspection may be performed after the current time on the plurality of to-be-inspected objects produced on the target production line based on the modified configuration parameter. Especially in the case of real-time quality inspection, the configuration parameters may be adjusted at any time to adapt to the current quality inspection situation.

In this embodiment, the configuration parameters may be adjusted during the quality inspection. The quality inspection debugging function may be triggered in a window interface of the quality inspection. For example, a “quality inspection debugging” key may be triggered in the window interface. Upon triggering the function, a second configuration interface may be displayed. The second configuration interface may refer to a schematic interface layout of the first configuration interface. A first configuration item, or a second configuration item, or both the first configuration item and the second configuration item may be included in the second configuration interface.

As described above, the first configuration item is used for setting configuration parameters for a plurality of quality inspection devices, and the second configuration item is used for setting configuration parameters for the defect detection model. In the second configuration interface, the first configuration item and the second configuration item may have configuration parameters already set, namely, original configuration parameters, and the original configuration parameters thereof may be set in the first configuration interface according to the above-mentioned embodiment.

The second configuration interface may also display a statistical result on the quality inspection results of the to-be-inspected objects subjected to quality inspection. The statistical result may include at least one of the following: the number of the to-be-inspected objects of which the quality inspection is completed within a unit time, the number of the to-be-inspected objects which have passed the quality inspection, the number of the to-be-inspected objects which have failed the quality inspection, and the number of the to-be-inspected objects which are missed in the quality inspection. The number of the to-be-inspected objects of which the quality inspection is completed within a unit time may reflect the speed of the quality inspection, and the number of the to-be-inspected objects which have passed the quality inspection, have failed the quality inspection, or are missed in the quality inspection may reflect the quality inspection precision and efficiency of the to-be-inspected objects by the defect detection model.

The above-mentioned statistical results may be displayed numerically, graphically, etc. on the second configuration interface, so as to assist the user to know the progress, accuracy, and the like of the quality inspection. Thus, the acquired configuration parameters of the device and the configuration parameters of the defect detection model may be adjusted adaptively.

Specifically, when the number of the to-be-inspected objects that can be subjected to the quality inspection within a unit time is less than the number of the to-be-inspected objects produced by the target production line within a unit time, the speed of the quality inspection may be increased. For example, by adjusting the movement rate of the image acquisition (movement rate of the camera or the controller), the acquisition frequency, and the like, more to-be-inspected objects may be subjected to quality inspection within a unit time. At the same time, a new quality inspection server may be configured to realize distributed defect detection via a distributed server so as to improve the efficiency of the quality inspection, or the software and hardware parameters provided by the server for the defect detection model may be configured, whereby the quality inspection server may invoke more computing resources as the defect detection model, so as to improve the quality inspection efficiency of the defect detection model.

The user can adjust the existing configuration parameters in the first configuration item and/or the second configuration item, and in response to the saving by the user, the user can record the configuration parameters after modifying the current configuration parameters of the configuration items (the first configuration item and the second configuration item) so as to associate the modified configuration parameters to the target production line.

The association may refer to: sending the modified configuration parameters to the corresponding device, whereby the corresponding device executes the corresponding task in the quality inspection according to the modified configuration parameters. For example, if the modified configuration parameters are configuration parameters of the camera, the modified configuration parameters would be sent to the camera, whereby the camera performs the image acquisition again according to the modified configuration parameters. For example, if the modified configuration parameters are configuration parameters of the defect detection model, the modified configuration parameters may be sent to the quality inspection server, whereby the quality inspection server performs defect detection according to the modified configuration parameters through the defect detection model.

Since corresponding parameters may be entered in the corresponding interface in the quality control system in the quality inspection, the rate, accuracy, and precision of the quality inspection can be adjusted, thereby facilitating the management and control of the quality inspection by the user. In addition, the configuration parameters may be adjusted by entering the configuration interface in the quality inspection process, whereby the rate, accuracy, and precision of the quality inspection can be adjusted according to the production condition of the to-be-inspected objects during the production process of the to-be-inspected objects on the target production line, to further adapt the production line at the front end.

In still other embodiments, the conveying speed of the to-be-inspected objects in the target production line can also be adjusted according to the quality inspection efficiency of the to-be-inspected objects. Specifically, the number of the to-be-inspected objects of which the quality inspection is completed within a unit time may be determined during the quality inspection of a plurality of to-be-inspected objects produced on the target production line. In addition, the conveying speed of the to-be-inspected objects on the target production line is adjusted based on the number. This situation can still be applied in the real-time quality inspection process. When applied in the real-time quality inspection process, the efficiency of the quality inspection can be balanced with the production efficiency of the to-be-inspected objects.

As described above, the number of to-be-inspected objects of which the quality inspection is completed within a unit time may reflect the speed of the quality inspection. If the speed of the quality inspection is too fast, the produced to-be-inspected objects will not keep up with the efficiency of the quality inspection. If the speed of the quality inspection is too slow, the speed of the quality inspection will not keep up with the production speed of the to-be-inspected objects, which may lead to the accumulation of the produced to-be-inspected objects in the quality inspection and affect the delivery speed of to-be-inspected objects.

In this embodiment, the conveying speed of the to-be-inspected objects produced by the target production line may be inversely adjusted according to the speed of the quality inspection. The conveying speed may refer to: a conveying speed of a conveyor belt where the to-be-inspected objects are transported to the quality inspection place after being produced from the target production line. That is, in order to ensure invariability of the efficiency of producing the to-be-inspected objects, the conveying speed of the produced to-be-inspected objects from the target production line to the quality inspection place can be adjusted to achieve the adaptation of the speed of the quality inspection and the conveying speed of the to-be-inspected objects, thereby avoiding the stacking of the to-be-inspected objects.

In a specific implementation, the conveying speed of the to-be-inspected objects on the target production line can be adjusted to be consistent with, or at least slightly different from, the speed of the quality inspection. When adjusting the conveying speed, the quality control system may send an instruction to a conveyor belt control device, whereby the conveyor belt control device adjusts the speed of the conveyor belt according to the instruction. The conveyor belt control device may be a motor, a pulley, or the like, and is not limited thereto.

With this embodiment, since the conveying speed of the to-be-inspected objects produced on the target production line may be controlled according to the speed of the quality inspection, the speed of the quality inspection and the speed of transporting the to-be-inspected objects to the quality inspection place may be matched, thereby reducing the accumulation of the to-be-inspected objects at the quality inspection place. Therefore, the quality inspection may be closely associated with the production line when being deeply implemented into the production line.

Hereinafter, the quality inspection shown in the present disclosure will be described.

As described above, the quality inspection may refer to the detection of defects in the to-be-detected region of the to-be-inspected object. The detection may be performed by using the defect detection model. In some embodiments, the quality inspection may be performed in a combination of rough inspection and fine inspection. The precision of the rough inspection is less than the precision of the fine inspection, whereby the efficiency of the quality inspection can be ensured by the rough inspection, and the accuracy of the quality inspection can be improved by the fine inspection.

FIG. 5 is a schematic diagram of a policy architecture showing how to perform the quality inspection under the quality control system shown in FIG. 2. Specifically, as described in Embodiment 1, different quality inspection servers may configure defect detection models with different detection precisions, and the policy of the quality inspection may be set by the material configuration unit in the detection module shown in FIG. 2. The material configuration unit may provide policy configuration options in a visual interface, for example, including: three configuration options including fine inspection, rough inspection, and fine inspection +rough inspection. A user can trigger a quality inspection function on a front-end browser interface and enter a window interface of the quality inspection. Then, a quality inspection policy setting key is triggered, that is, the policy configuration options provided by the material configuration unit may be used. One policy configuration option may be associated with a corresponding quality inspection invoking logic program in the background. The quality inspection invoking logic program may build a hardware and software environment under each quality inspection policy thereof and the communication of the hardware quality inspection via a computer instruction, so as to guide the flow direction of the images acquired by the to-be-inspected objects on the target production line, and the processing precision.

In a specific implementation method, when performing the quality inspection, at least one image may be inputted into a first model so as to perform a first quality inspection on the to-be-inspected objects. When a result of the first quality inspection indicates that the quality inspection fails, at least one image acquisition is re-performed on the to-be-inspected objects, and the re-acquired image is inputted into the second model so as to perform a second quality inspection on the to-be-inspected objects.

The quality inspection precision of the first quality inspection is less than the quality inspection precision of the second quality inspection.

In this embodiment, in order to improve the efficiency of quality inspection, when the first model is used for the rough inspection, the image acquisition device may be instructed to perform the image acquisition on the to-be-inspected objects according to a preset first resolution and a first acquisition precision. The preset first resolution may be a lower resolution, and the first acquisition precision may be a lower precision. The acquisition precision may refer to a focal length corresponding to the image acquisition performed on a position of a to-be-detected region by the camera so as to control the degree of details of the image acquisition. Since the acquisition resolution is lower and the acquisition precision is also lower, rapid acquisition can be achieved. At the same time, images with the lower resolution and the lower acquisition precision can reduce the computation of the first model, thus improving the efficiency of defect detection and then improving the quality inspection efficiency.

If the first model detects that the quality inspection of a to-be-inspected object fails, the image acquisition may be performed again on the to-be-inspected object. When the image acquisition is performed again, the image acquisition apparatus may be instructed to perform the image acquisition on the position where the to-be-inspected object has a defect, or the image acquisition apparatus may be instructed to perform the image acquisition again on the to-be-detected region of the whole to-be-inspected object. Certainly, the former may be preferred in order to improve efficiency.

When the image acquisition is performed again, the image acquisition may be performed according to a preset second resolution and a second acquisition precision. The preset second resolution is greater than the preset first resolution, and the second acquisition precision is higher than the first acquisition precision. In this way, the resolution and the degree of the details of an image in the fine inspection can be improved, and the acquired image is sent to the second model. Since the resolution and the precision of the image sent to the second model are higher, the second model may perform defect detection with higher precision on the to-be-inspected object, thereby ensuring the accuracy of quality inspection.

The image acquisition apparatus for performing the image acquisition during the rough inspection may be different from the image acquisition apparatus for performing the image acquisition during the fine inspection. The first model and the second model may be configured into different quality inspection servers, respectively.

As shown in FIG. 5, the first model may be configured into a first quality inspection server (1) (rough inspection server), and the second model may be configured into a second quality inspection server (2) (fine inspection server). The rough inspection server may be connected to a rough inspection camera, and the fine inspection server may be connected to a fine inspection camera. When the rough inspection server outputs that the quality inspection of the to-be-inspected object fails, an instruction may be sent to the fine inspection server and the fine inspection camera so as to instruct the fine inspection camera to perform the image acquisition again on the to-be-inspected object according to the second resolution and the second precision, and the acquired image is sent to the fine inspection server for the fine inspection.

In some examples, both the rough inspection server and the fine detection server may store the quality inspection result of the to-be-inspected object, and the quality inspection result may be fed back to the control object and the data server, whereby the control object and the data server perform statistical analysis on the quality inspection result.

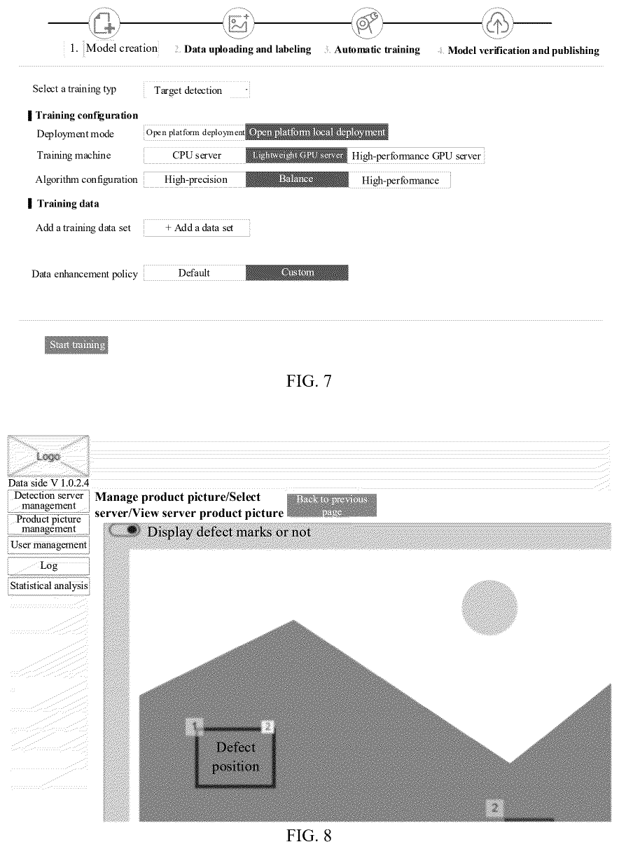

Hereinafter, the construction of the defect detection model used in the quality inspection of the present disclosure is described. Referring to FIG. 6 and FIG. 7. FIG. 6 is a flow chart showing construction steps of a defect detection model according to the present disclosure, and FIG. 7 shows a schematic interface diagram of a third configuration interface at the time of construction of a defect detection model. As shown in FIG. 6, the flow specifically includes the following steps:

Step S601: In response to a triggered model construction function, displaying a third configuration interface, where the third configuration interface includes at least one trigger control, and different trigger controls are used for triggering different configuration windows in a model construction process.

Step S602: Determining configuration options selected in different configuration windows.

Step S603: Based on preset configuration parameters corresponding to the selected configuration options, obtaining a defect detection model through training by using a pre-stored first data set as a training sample.

In this embodiment, in addition to the above-mentioned quality inspection function button and debugging function button, the system interface may further include a model setting button. A window interface of model setting may be entered by triggering the model setting button. The window interface of the model setting may correspond to the model management module shown in FIG. 2. A model construction function is triggered on the window interface so as to enter a third configuration interface. At least one trigger control may be controlled in the third configuration interface. When the trigger control is triggered, for example, being clicked or doubly clicked or touched, a corresponding configuration window may be entered, so as to enter a corresponding construction stage in the model construction process and perform parameter setting on the construction stage.

In general, the model construction process may be divided into: a model creation stage, a data uploading stage, a data labeling stage, a training stage, and a publishing stage. The model creation stage is used for creating an initial neural network model, for example, selecting a neural network model with a certain network structure. The data uploading stage generally needs to upload a data sample for model training. The data sample is a labeled sample or an unlabeled sample, and may also contain both the labeled sample and the unlabeled sample. The data labeling stage is used for labeling the uploaded unlabeled data. The training stage is to train the established neural network model based on the labeled data samples so as to update parameters in the neural network. The publishing phase is used for publishing the trained model, for example, being deployed and published to the cloud or being deployed to a server of a local area network.

A plurality of configuration options may be preset in the configuration window for selection by a user. Different configuration options may correspond to different preset configuration parameters. In this way, the user can start to train a model only by selecting a certain configuration option according to requirements, without requiring the user to input a model parameter with a higher requirement for a professional level. For example, in the model creation stage, in a configuration window entered thereby, the following configuration options may be provided: a lightweight model, a high-precision model, a multi-task model, and the like. Each configuration option may be associated with a preset neural network. The associated neural network may be designed by a technician in advance and stored in the quality control system. In this way, the user only needs to select a model according to quality inspection requirements, and does not need to build a model by himself, thereby reducing the technical threshold for the user to use this function.

As shown in FIG. 7, four trigger controls of model creation, data uploading and labeling, automatic training, and model verification publishing are shown. When the automatic training is triggered, the configuration window entered thereby contains a plurality of configuration options. For example, in a deployment mode, the configuration options may include: an open platform deployment and an open platform local deployment.

A training machine includes options such as a CPU server, a lightweight GPU server, and a high-performance GPU server. As shown in FIG. 2, a plurality of servers are included in the infrastructure layer, and the plurality of servers may include a quality inspection server, a data server, and an industrial control server. Then, in this example, training servers of various hardware configurations may be included, for example, including a CPU server, a light-weight GPU server, and a high-performance GPU server. By selecting a certain type of configuration in the configuration options of the training machine, the corresponding training server in the infrastructure layer may be invoked, so as to complete training of a model via the invoked training server. Then, the model is published to the selected quality inspection server.

In an algorithm configuration, configuration options such as high precision, balance, and high performance may be included. Each configuration option corresponds to a preset configuration parameter so as to only require the user to select according to requirements. In subsequent training and publishing, according to the preset configuration parameter corresponding to the configuration option selected by the user, a data set may be obtained, a neural network may be trained to obtain a defect detection model, and the defect detection model may be published automatically.

The obtained first data set may also be obtained based on a configuration option selected by the user in the window interface for data uploading and labeling. In general, data sets for training the defect detection model may be pre-stored in the quality control system. These data sets may be obtained by labeling in advance by the user, and may be referred to as initial data sets for training the defect detection model. In some embodiments, different data sets may be constructed for different production lines, and the first data set may be a data set selected by the user according to the production line.

In practice, the user constructing the model only needs to select a data set, but may not label the data set. Certainly, in some examples, the user constructing the model may simply label the data, which is not limited here.

Accordingly, in the process of quality inspection, as the quality inspection progresses, more data is accumulated. That is, a larger number of images of the to-be-inspected objects may be obtained, whereby a large amount of labeled data may be obtained according to the quality inspection results of these to-be-inspected objects so as to update the defect detection model. Certainly, the data may be used for constructing a defect detection model for detecting other defect types.

In some embodiments, a second data set may be obtained in response to a triggered model update function after the quality inspection of a plurality of to-be-inspected objects produced on a target production line. The defect detection model is updated by using the second data set as a training sample. Next, the defect detection model subjected to the quality inspection at the current time may be replaced with an updated defect detection model.

The second data set includes a plurality of target image samples, and the target image samples include regions for re-labeling defect regions of the to-be-inspected objects subjected to the quality inspection.

In this embodiment, the second data set may include a target image sample of the to-be-inspected object subjected to the quality inspection on the target production line, and thus the generalization performance of the updated defect detection model can be improved. Specifically, the second data set may be an image sample of an erroneously-inspected to-be-inspected object, and thus a difficult sample may be constructed to improve the detection accuracy of the updated defect detection model.

The target image sample may include a labeling frame for labeling a defect position. The labeling frame may perform labeling by the defect detection model when performing defect detection, or may perform labeling manually, which is not limited thereto.

As shown in FIG. 14, the triggered model update function may be triggered on the window interface of the model setting. For example, after triggering a “model update” key, this function is triggered. In some examples, the defect detection model may be updated with the second data set by using a configuration option selected by the user in the third configuration interface for the automatic training stage in response to the triggering of the model update function.

Certainly, in still other examples, a corresponding configuration interface may be displayed in response to the triggering of the model update function. The configuration interface may include a plurality of configuration options related to the model update. After the user selects a corresponding configuration option according to requirements, the quality control system may start updating the defect detection model by using the second data set according to a preset configuration parameter corresponding to the selected configuration option.

After the defect detection model is updated, an updated defect detection model may be obtained. In practice, the updated defect detection model may be automatically deployed to the target production line according to the configuration option selected by the user in the third configuration interface for a model deployment mode, so as to replace the defect detection model performing the quality inspection at the current time with the updated defect detection model.

In some embodiments, if the target image sample in the second data set is an erroneously-inspected image sample of a to-be-inspected object, the erroneously-inspected image needs to be labeled with a defect position so as to obtain the second data set. In practice, an interface may be provided for the user to label the second data set, and at the same time, the user may also perform verification, error correction, and labeling of the quality inspection results in the interface.

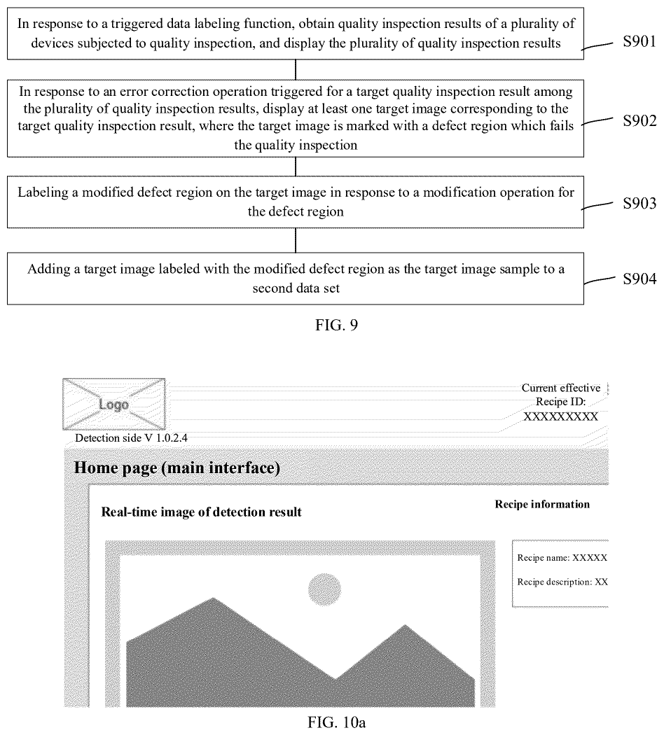

With reference to FIG. 8 and FIG. 9, FIG. 8 shows an interface for obtaining a second data set, and FIG. 9 is a flow chart showing the steps of obtaining a second data set. As shown in FIG. 9, the flow may specifically include the following steps:

Step S901: In response to a triggered data labeling function, obtaining quality inspection results of a plurality of to-be-inspected objects subjected to the quality inspection, and display the plurality of quality inspection results.

In this embodiment, the triggered data labeling function may be triggered in the window interface of the quality inspection, or may be triggered in the window interface of the model setting. That is, in practice, the data labeling function may be set in the two interfaces, so as to perform error correction, labeling, and verification on the quality inspection result.

After the data labeling function is triggered, the quality control system may obtain the quality inspection results of a plurality of to-be-inspected objects subjected to the quality inspection from the quality inspection server or the data server corresponding to the target production line, and display the plurality of quality inspection results. When the plurality of quality inspection results are displayed, the quality inspection results may be displayed in a quality inspection result display interface. The quality inspection result display interface may be understood to be a window interface corresponding to the data labeling function.

When displaying the plurality of quality inspection results, the quality inspection results of the to-be-inspected objects may be displayed in sequence according to the time sequence of the to-be-inspected objects being subjected to the quality inspection. The displayed quality inspection result may be a result of whether the quality inspection is passed.

In some examples, as shown in FIG. 8, the displayed quality inspection result may also include each image of the to-be-inspected object and a result of whether the image has passed the defect detection. In still other examples, the displayed quality inspection result may further include a schematic diagram of marking all the defect regions detected on the to-be-inspected object which fails the quality inspection. The lower right corner of FIG. 8 shows a schematic diagram of a position where the to-be-inspected object is detected to be defective.

Specifically, the visual interface of FIG. 8 is described: mainly including the following functions:

Large picture browsing: the main space of a page is a large picture of a current picture, which may be zoomed by a mouse wheel, and the schematic diagram of the lower right corner represents the proportion of the current zoom to the original picture. In a specific implementation, when it is detected that the large picture browsing is triggered in a front-end browser page, instruction information of the large picture browsing may be generated in the background. A data packet containing the instruction information is transmitted to a display server via a message queue, and is converted into a large picture to be presented in the front-end via the display server through a preset protocol and code.

Whether a defect mark is displayed: it is determined whether to label and display a defect position on the picture through a switch at the upper left corner of the large picture, and if the switch is turned on, the system will display an identification box at the defect position. In a specific implementation, when it is detected that a display defect mark is triggered in the front-end browser page, instruction information of the display defect mark may be generated in the background. A data packet containing the instruction information is transmitted to a display server via a message queue. An identification frame coordinate of the defect position of each image is obtained via the display server through a preset protocol and code, and the identification frame is rendered in an image presented in the front-end according to the identification frame coordinate.

Mouse coordinate display: a position coordinate of a current mouse is displayed in the upper right corner of the picture.

Picture list: for each product material, a detector takes some pictures, and an image list is displayed below the page, which is linked with the large image map and the schematic diagram of the lower right corner. In a specific implementation, when it is detected that picture list display is triggered in the front-end browser page, the instruction information of a display defect mark may be generated in the background. A data packet containing the instruction information is transmitted to a display server via a message queue. A plurality of requested images are obtained from the data server or the quality inspection server via the display server. The plurality of images obtained are presented in a list form in the front-end according to a preset protocol and code.

The list order corresponds to a shooting order, and also reflects a relative position at the edge of the material. The list order and the shooting order may be pre-configured into a background protocol and code, whereby the plurality of images obtained are displayed according to the list order and the shooting order.

Each image is accompanied by a state distinction of NG/OK for the user to distinguish. When the function that an accompanied state distinction is detected in the front-end browser page is triggered, the background generates instruction information of state obtaining. A data packet containing the instruction information is transmitted to a display server via a message queue. State information (indicating whether the quality inspection is passed or not) corresponding to a plurality of images is obtained from the data server or the quality inspection server via the display server. The obtained state information is rendered in the plurality of images in the front end according to a preset protocol and code.

An input box and a pull-down menu in the upper left corner of the image list support the retrieval and classified retrieval of the images.

Manual determination: it is manually determined whether there is a defect in an image through OK and NG buttons. If it is found that a machine detection result is incorrect, it is feasible to re-label the image data. The labeled image may be used for iterating a model of a next version, namely, as the second data set.

Step S902: In response to an error correction operation triggered for a target quality inspection result among the plurality of quality inspection results, displaying at least one target image corresponding to the target quality inspection result, where the target image is marked with a defect region which fails the quality inspection.

In this embodiment, the target quality inspection result corresponds to a to-be-inspected object. Since a plurality of images may be acquired from a to-be-inspected object, a plurality of target images corresponding to the target quality inspection result and a result that whether the target images pass the defect detection may be displayed in the quality inspection result display interface.

The result that whether the target images pass the defect detection may be marked by identification, so that the user can intuitively understand.

In some embodiments, a selected target image and a marked defect region of the target image may be zoomed in at a labeling window in response to a selection operation on the target image. For example, as described in FIG. 8, when a left-most image is selected, the left-most image may be zoomed in, and a defect region detected at the time of the quality inspection is displayed.

Step S903: Labeling a modified defect region on the target image in response to a modification operation for the defect region.

In this embodiment, the defect region of the selected target image may be modified. Specifically, the quality inspection result display interface may provide a labeling tool, such as a rectangular box. The user can re-label a correct defect region by using the labeling tool. Next, the defect region of the selected target image detected during the quality inspection may be removed, so as to realize the verification and error correction of the quality inspection.

Step S904: Adding a target image labeled with the modified defect region as the target image sample to a second data set.

Accordingly, the target image labeled with the modified defect region may be saved to the second data set in response to the user saving the modified defect region.

With this implementation, it is possible to continuously collect images and quality inspection results of the to-be-inspected objects as the second data set during the process that the target production line produces the to-be-inspected objects and performs the quality inspection on the to-be-inspected objects, so as to update the defect detection model, thereby improving the accuracy of the defect detection model.

As shown in the above embodiment, the defect detection model may include a first model and a second model. When updating the defect detection model, the first model may be updated by using the second data set, or the second model may be updated, or the two models may be updated.

In this case, the second data set may include a data set originating from the rough inspection server and a data set originating from the fine inspection server. When updating the first model, the first model may be updated by using a data set obtained from images and results of a to-be-inspected object subjected to the defect detection through the first model, such as the data set originating from the rough inspection server. Similarly, when updating the second model, the second model may be updated by using a data set obtained from images and results of a to-be-inspected object subjected to the defect detection through the second model, such as the data set originating from the fine inspection server.

Thus, it is possible to update the first model for the rough inspection and the second model for the fine detection in the quality inspection combined with the rough inspection and the fine detection in a targeted manner, so as to achieve the targeted update and improve the update efficiency.

In some embodiments, the quality inspection may include quality inspection on a plurality of defect types of a to-be-inspected object, such as the multi-task model mentioned above. The defect detection model includes detection branches corresponding to the plurality of defect types, and different detection branches correspond to different defect types. Accordingly, when updating the defect detection model, according to a defect type where the quality inspection has an error, parameters of the detection branch corresponding to the defect type in the defect detection model may be updated, while parameters of other detection branches are reserved. Thus, the update efficiency of the defect detection model can be improved, thereby matching the production efficiency of the to-be-inspected object of the target production line.

In a specific implementation, in response to a selection operation on at least one defect type among the plurality of defect types, a labeling subset corresponding to the selected defect type may be obtained from the second data set, where a labeled defect region of a target image sample in the labeling subset corresponds to the defect type.

Next, the detection branch corresponding to the selected defect type in the defect detection model is updated by using the labeling subset.

In this embodiment, a plurality of defect types of a to-be-inspected object may be detected. It should be noted that the plurality of defect types may refer to the same defect which may occur in the same region. For example, a display substrate is taken as an example. When cutting the display substrate, the defect types which may occur at a cutting edge include: uneven cutting, breaking in the cutting, and edge cracks caused by cutting. In practice, it is necessary to detect the above defects in the quality inspection.

In this embodiment, a defect detection model may be used to detect a plurality of defect types in a to-be-detected region of a to-be-inspected object. Specifically, images acquired for the to-be-inspected object may be respectively inputted into a plurality of detection branches after being subjected to feature extraction, and the extracted features are processed through different detection branches so as to determine whether the to-be-inspected object has a defect of a corresponding type.

In practice, if it is determined that the detection precision of a certain defect type is not high, the detection branch of the defect type may be updated. In practice, a labeling subset corresponding to the defect type may be collected, and a labeled defect region of a target image sample included in the labeling subset corresponds to the defect type. For example, if the defect type required to be updated is a defect of a breaking type, an image sample of a to-be-inspected object having a breaking defect may be collected, and a breaking position and a breaking label may be labeled, thereby obtaining the labeling subset of the breaking type.

Next, parameters of the detected branches in the defect detection model corresponding to the at least one defect type may be updated by using the labeling subset. In practice, when updating, as described above, a configuration option for updating a certain detection branch or several detection branches of the defect detection model may also be triggered after a “model update” key is triggered on a window interface of model setting, and then only a part of the detection branches of the defect detection model may be updated according to the update logic corresponding to the configuration option, whereby the calculation amount during updating can be reduced, computer resources can be saved, and the update efficiency and update pertinence of the defect detection model can be improved.

In still other embodiments, the defect detection model of the target production line may be migrated to other production lines related to the target production line, to detect defects of the to-be-inspected objects on the other production lines by using the defect detection model of the target production line and the corresponding configuration parameters. The defect types of the to-be-inspected objects to be detected by the other production lines are the same as or similar to the defect type of the to-be-inspected object to be detected by the target production line.

For example, if a production line 1 performs the defect detection on a cutting edge of an array substrate in a display panel while a production line 2 performs the defect detection on a cutting edge of a color film substrate, a defect detection model of the production line 1 may be migrated to the production line 2 for the defect detection. The array substrate and the color film substrate are two celling panels in a liquid crystal display panel LCD.

In a specific implementation, when it is detected that an associated production line associated with the target production line operates, the configuration parameters may be associated to the associated production line in response to a triggered parameter migration function. Next, based on the configuration parameters, the quality inspection is performed on a plurality of to-be-inspected objects produced on the associated production line by using the defect detection model.

Defects of the to-be-inspected objects targeted by the quality inspection in the associated production line are the same as or similar to defects of the to-be-inspected objects targeted by the quality inspection in the target production line. The similarity means that the degree of similarity between the defects of the to-be-inspected objects in the associated production line and the defects of the to-be-inspected objects in the target production line is less than a preset degree of similarity, such as a breaking defect and a cut corner defect.

In this embodiment, the associated production line is related to the target production line, and the defect types targeted by the defect detection to be performed on the to-be-inspected objects therein are the same or similar. Thus, the configuration parameters and the defect detection model used when the target production line performs the quality inspection on the to-be-inspected objects may be applied to the associated production line to perform the quality inspection on the to-be-inspected objects.

The parameter migration function may be triggered by a user, or may be triggered automatically when it is automatically detected that the associated production line is online. After the parameter migration function is triggered, configuration parameters of the target production line may be obtained first. It will be understood that these configuration parameters may include working parameters of a device for the quality inspection in the associated production line, and threshold parameters of the defect detection model or working parameters of the server.

Next, the working parameters of the device for the quality inspection may be sent to a corresponding device, whereby the device starts to perform the image acquisition on the to-be-inspected objects produced on the associated production line based on the working parameters, and sends acquired images to the server corresponding to the associated production line. The server starts the defect detection on the to-be-inspected objects based on the threshold parameters of the defect detection model and the working parameters thereof, and determines the quality inspection results according to the result of the defect detection.

With this implementation, the existing quality inspection logic of production lines may be reused through the parameter migration function of the quality control system, and the user does not need to re-set the quality inspection logic for the associated production line. Thus, the intercommunication and depreciation between the production lines can be realized through the parameter migration, so as to make full use of resources and reduce the labor cost of workers.

Accordingly, in some embodiments, if the defects of the to-be-inspected objects targeted by the quality inspection in the associated production line are similar to the defects of the to-be-inspected objects targeted by the quality inspection in the target production line, it is characterized that the defect types are not completely the same. In practice, the defect detection model of the target production line may be updated according to the image samples of the to-be-inspected objects produced on the associated production line, so as to obtain the defect detection model adapted to the associated production line, thereby improving the quality inspection accuracy of the to-be-inspected objects produced on the associated production line.

In a specific implementation, a target data set corresponding to the associated production line may be obtained. The target data set includes the image samples after the image acquisition and labeling on the plurality of to-be-inspected objects on the associated production line. In response to a triggered model migration function, the defect detection model is updated by using the target data set to obtain a migration model.

Accordingly, when performing the quality inspection on the plurality of to-be-inspected objects produced on the associated production line by using the defect detection model based on the configuration parameters, the quality inspection may be performed on the plurality of to-be-inspected objects produced on the associated production line by using the migration model based on the configuration parameters.

In this embodiment, the image samples in the target data set may be obtained by performing the image acquisition on the plurality of to-be-inspected objects on the associated production line, and defect positions and defect types are labeled in the image samples. Thus, after a “model update” key is triggered on the window interface of model setting, the defect detection model may be automatically updated by using the target data set. At this moment, defects on the associated production line are labeled in the image samples in the adopted target data set. Therefore, after updating the defect detection model, the updated model may be called a migration model. The migration model may perform the defect detection on the to-be-inspected objects produced on the associated production line.

For example, the defects of the to-be-inspected objects on the associated production line are breaking defects, and the defects of the to-be-inspected objects on the target production line are cut corner defects. The defects labeled on the image samples in the target data set are the cut corner defects. After the defect detection model is trained by the target data set, the defect detection model can improve the detection precision of the to-be-inspected objects having the cut corner defects, whereby a detection model for the cut corner defects does not need to be reconstructed, thereby reducing the quality inspection configuration for the associated production line.

Next, how to debug the target production line is explained.

The regulation needs to be performed according to the quality inspection results of the quality inspection on the to-be-inspected objects. In some embodiments, the statistics of the quality inspection results may be automatically performed on the to-be-inspected objects subjected to quality inspection. The statistics may include the statistics of the number of to-be-inspected objects which have passed the quality inspection, the statistics of a time period during at which the to-be-inspected objects which have failed the quality inspection are subjected to the quality inspection, the statistics of defect positions in the to-be-inspected objects which have failed the quality inspection, and the statistics of the defect types, so as to provide the basis for debugging the target production line according to the number, the time period distribution, and the distribution of the defect positions and the defect types.

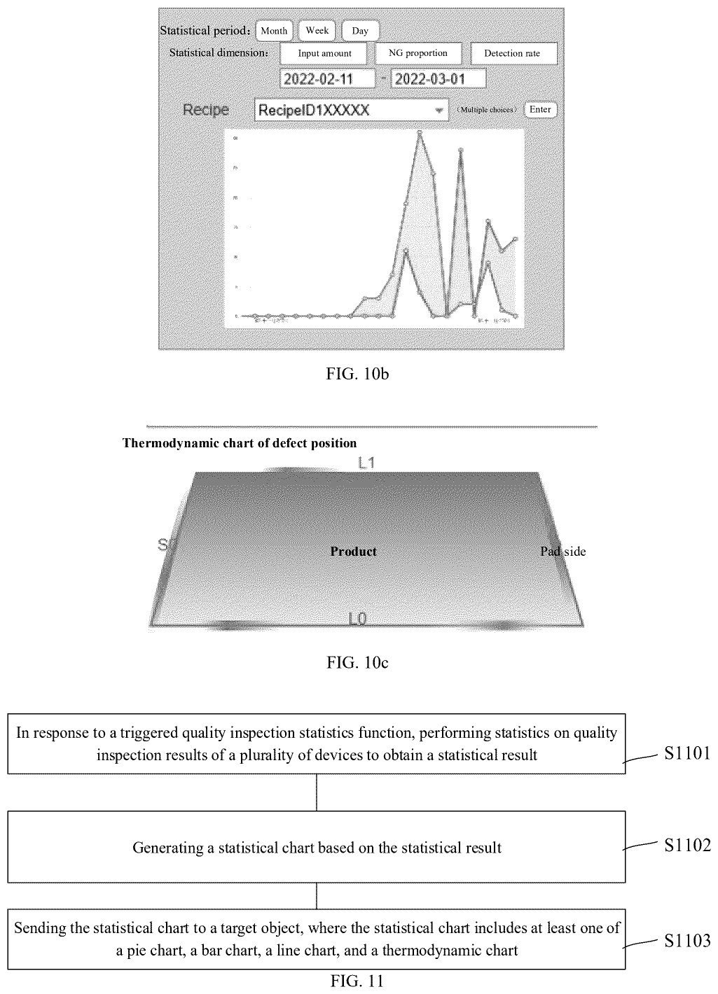

With reference to FIGS. 10a-10c and 11, FIGS. 10a-10c show schematic interface diagrams of statistics on quality inspection results, and FIG. 11 is a flow chart showing the steps of performing statistics on quality inspection results. As shown in FIG. 11, the flow may specifically include the following steps:

Step S1101: In response to a triggered quality inspection statistics function, performing statistics on quality inspection results of a plurality of to-be-inspected objects to obtain a statistical result.

Step S1102: Generating a statistical chart based on the statistical result.

Step S1103: Sending the statistical chart to a control object, where the statistical chart includes at least one of a pie chart, a bar chart, a line chart, and a thermodynamic chart.

The quality inspection statistics function may also be triggered in a window interface of the quality inspection. When this function is triggered, statistical results are displayed in the control object. The statistical results may be in the form of a statistical chart. As described above, the control object is a window interface for setting regulation in the industrial control system, the detection module or the quality control system.

The statistical chart may be fed back to the control object corresponding to the target production line for display, and the displayed interface thereof is as shown in FIG. 10a. The interface may include a main interface and an auxiliary interface for displaying the statistical chart. The main interface may be used for displaying the quality inspection result of a specific to-be-inspected object, including a defect position image of the to-be-inspected object. The auxiliary interface is used for displaying the statistical chart, which is a broken line chart. FIG. 10b shows a schematic diagram of an auxiliary interface in FIG. 10a. In addition to displaying the statistical chart, information about the to-be-inspected object, such as a statistical dimension and a category, may also be displayed. FIG. 10c shows a schematic diagram of an auxiliary interface in FIG. 10a, which shows a thermodynamic chart of a quality inspection result. The position distribution of defects of a large number in a batch of to-be-inspected objects may be visually understood from the thermodynamic chart.

In FIG. 10a, a real-time picture taken by a current camera is displayed on the left side, and information of a current Recipe is displayed on the right side. A button for parameter configuration may be clicked to enter a system parameter configuration category policy page, namely, a second configuration interface. A no good (NG) list in a current day of this detector is displayed in a daily NG list, and the right side of PanelID is clicked to display a picture. Data statistics show the statistics of the number of photographs today, the number of detections that have been completed, the input amount of statistical support for NG data, and the detection rate of an NG proportion. Different time ranges and periods are selected and may be displayed as a pie chart and a line chart (detection rate: number of NG points/total number of pictures during this time period).

For a thermodynamic chart, the thermodynamic chart of a defect position is provided. Certainly, It is also possible to provide a data analysis and visualization chart of different dimensions of defects over time and product models, so as to allow users to extend the analysis from the regular phenomenon of defect detection in a single point process to the upstream and downstream of the whole process flow, find systematic problems in the production process, optimize the process flow, and create greater service values.

In some embodiments, when performing statistics on quality inspection results, at least one of the following dimensions may be used:

Dimension 1: Performing statistics on the quality inspection results of the plurality of to-be-inspected objects according to positions where defects occur.

Dimension 2: Performing statistics on the quality inspection results of the plurality of to-be-inspected objects according to a time period in which the to-be-inspected objects are produced.

Dimension 3: Performing statistics on the quality inspection results of the plurality of to-be-inspected objects according to the types of defects, where the quality inspection is used for detecting a plurality of defect types of the to-be-inspected objects.

When performing statistics according to a defect position, to-be-inspected objects which have a defect at the same position may be classified to obtain the number of the to-be-inspected objects, and the number of the to-be-inspected objects is taken as a statistical result of the position, thereby obtaining statistical results of a plurality of positions.

When performing statistics according to the time period of production of the to-be-inspected objects, statistics may be performed on the number of to-be-inspected objects which have passed the quality inspection and failed the quality inspection in the same time period of production to obtain a quality inspection statistical result related to the time period.

When performing statistics according to a defect type, to-be-inspected objects which have the same defect may be classified to obtain the number of the to-be-inspected objects, and the number of the to-be-inspected objects is taken as a statistical result of the defect of this type, thereby obtaining statistical results of a plurality of defect types.

In practice, the above-mentioned three dimensions may be mutually combined to obtain statistical results of the quality inspection related to the defect position, the defect type, and the time period, and thus the process quality of the target production line may be comprehensively reflected from various dimensions.

When the target production line is regulated based on the quality inspection result of at least one to-be-inspected object in response to a second preset condition triggered on the control object, since the statistical chart may feed back the distribution of the quality inspection results on the number, time period distribution, defect position, and defect type, in some examples, quality inspection information corresponding to a certain region of the statistical chart may be displayed directly in response to a preset operation triggered on the region so as to indicate the number, time period distribution, and defect position distribution represented by the statistical region, whereby the user can input corresponding debugging parameters according to the number, time period distribution, and defect position distribution represented by the statistical region to debug the target production line.

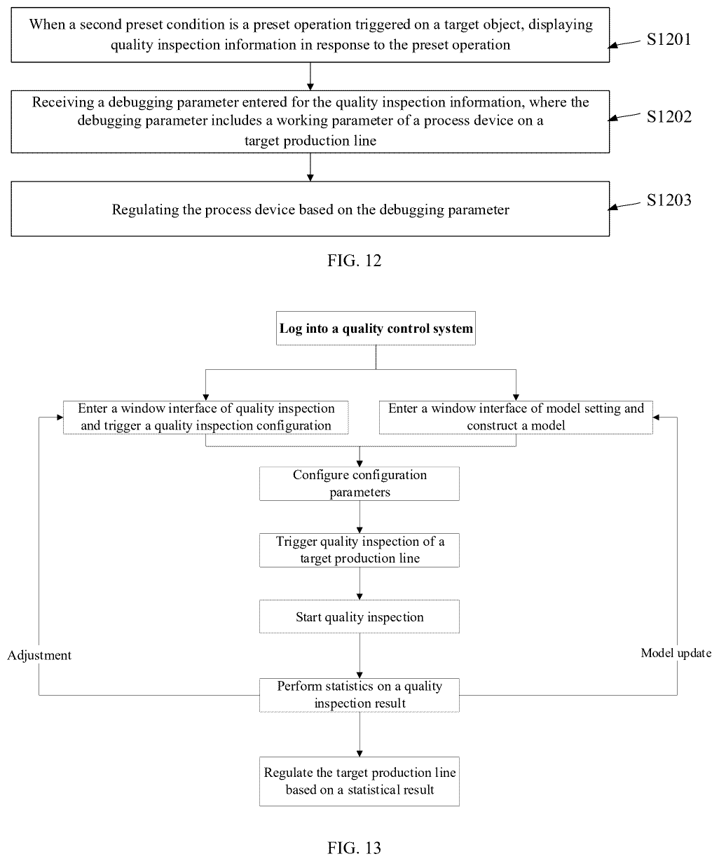

FIG. 12 is a flow chart showing the steps of regulating a target production line. As shown in FIG. 12, in some examples, the debugging may include the following steps:

Step S1201: When a second preset condition is a preset operation triggered on a control object, displaying quality inspection information in response to the preset operation.

The quality inspection information includes at least one of a target defect position, a target time period, and a target defect type, where the number of the to-be-inspected objects having a defect at the target defect position exceeds a first preset number, the number of the to-be-inspected objects failing the quality inspection in the target time period exceeds a second preset number, and the number of the to-be-inspected objects having a defect of the target defect type exceeds a third preset number.

Step S1202: Receiving a debugging parameter entered for the quality inspection information, where the debugging parameter includes a working parameter of a process device on a target production line.

Step S1203: Regulating the process device based on the debugging parameter.

In this embodiment, the triggering of the preset operation may characterize a statistical result of a large quality inspection problem that a user wishes to know, and thus the quality control system may display the quality inspection information after analyzing the statistical result of the quality inspection result.

The quality inspection information includes at least one of a target defect position, a target time period, and a target defect type. As described above, the target defect position refers to: the number of the to-be-inspected objects that have a defect at the position exceeds a first preset number, characterizing that a failure has occurred in the process flow here, resulting in a low quality inspection passing rate.

The target time period refers to: the probability of failing the quality inspection of the to-be-inspected objects produced in this time period is large.

The target defect type refers to: there are a large number of the to-be-inspected objects that have defects of the target defect type, characterizing that the corresponding process device has failed.

The above-mentioned first preset number, second preset number, and third preset number may all be set according to the product yield corresponding to the target production line, which will not be described in detail herein.

The quality inspection information may include any one, two, or three of the above. Next, the user can enter a debugging parameter according to the displayed quality inspection information. The quality control system may send the debugging parameter to the corresponding process device so as to regulate the process device, or send the debugging parameter to the industrial control system of the target production line to regulate the process flow.

With reference to FIG. 13 and FIG. 14, FIG. 13 is a complete flow chart of quality control according to the present disclosure, and FIG. 14 shows a schematic interface setting diagram of a quality control system according to the present disclosure. With reference to FIG. 13 and FIG. 14, the quality control method of the present disclosure is exemplified by taking the target production line as a production line for cutting a display panel:

S1: Firstly, a user logs into a quality control system, enters a system interface, clicks a button of a quality inspection function, enters a window interface of quality inspection, and triggers a quality inspection configuration in the window interface, so as to enter a first configuration interface. The first configuration interface is as shown in FIG. 4.

S2: The quality control system receives configuration parameters entered by a plurality of configuration items (first configuration item and second configuration item) on the first configuration interface by the user, including working parameters of a camera, a PLC, a trigger, and a server, and threshold parameters of a model, and associates the configuration parameters to a target production line.

S3: Next, the user can trigger model setting so as to enter a window interface of the model setting. In the window interface, model construction and model update functions may be included. Specifically, the model construction is firstly triggered to enter the window interface described in FIG. 7.

S4: Different trigger controls are displayed in the window interface shown in FIG. 7. When different trigger controls are triggered, a plurality of corresponding configuration options are displayed. After the user selects a corresponding configuration option according to requirements, the quality control system starts to automatically train a defect detection model used by the target production line.

S5: After the model is published and the configuration parameters are set, the user returns to the window interface of the quality inspection, and triggers the quality inspection in the window interface, whereby the quality control system starts to perform the quality inspection on devices produced on the target production line by using the constructed defect detection model according to the associated configuration parameters.

S6: In a quality inspection process, the user clicks quality inspection and debugging on the window interface of the quality inspection, and then a quality inspection debugging function is triggered, so as to display a target configuration item, a quality inspection result of a currently device subjected to quality inspection, a quality inspection number, and the like on a second configuration interface, and the devices which have failed the quality inspection and passed the quality inspection are statistically analyzed.

S7: The configuration parameters in the target configuration item are modified based on the displayed quality inspection statistical analysis result, and the quality inspection is performed after the current time based on the modified configuration parameters.

S8: After a period of the quality inspection, a regulation function is triggered on a system interface, and then a window interface of the regulation is entered. In the interface, a quality inspection statistics key is clicked to enter the interface shown in FIG. 10a, so as to visually display the statistical results of the quality inspection.

S9: Next, production line regulation is triggered in the window interface of the regulation, namely, a second preset condition is triggered. Then, the quality inspection information starts to be displayed. The quality inspection information may be obtained based on further analysis of the quality inspection statistics, and includes at least one of a target defect position, a target time period, and a target defect type.

S10: Debugging parameters are entered in the interface of the production line regulation, and the quality control system sends the debugging parameters to a process device on the target production line, so as to realize the regulation of the process device.

S11: When a new associated production line associated with a target production line runs online, a production line migration function is triggered in the system interface to enter a window interface of the migration.

S12: In the window interface of the migration, two functions of model migration and parameter migration may be included. In practice, after the two functions, a target production line to be migrated, and the migrated associated production line are selected, the configuration parameters and the defect detection model of the target production line start to be associated to the associated production line, whereby the associated production line directly uses the configuration parameters and the defect detection model of the target production line to perform the quality inspection on the devices.

Certainly, as shown in FIG. 13, the above processes are operable by obtaining corresponding permissions, and the permissions may be determined by a user information management unit. For example, each corresponding function button in FIG. 14 may check that the user has corresponding permissions and then enter corresponding window interfaces. For details, please refer to the description of the above-mentioned embodiments, and the details will not be repeated herein.

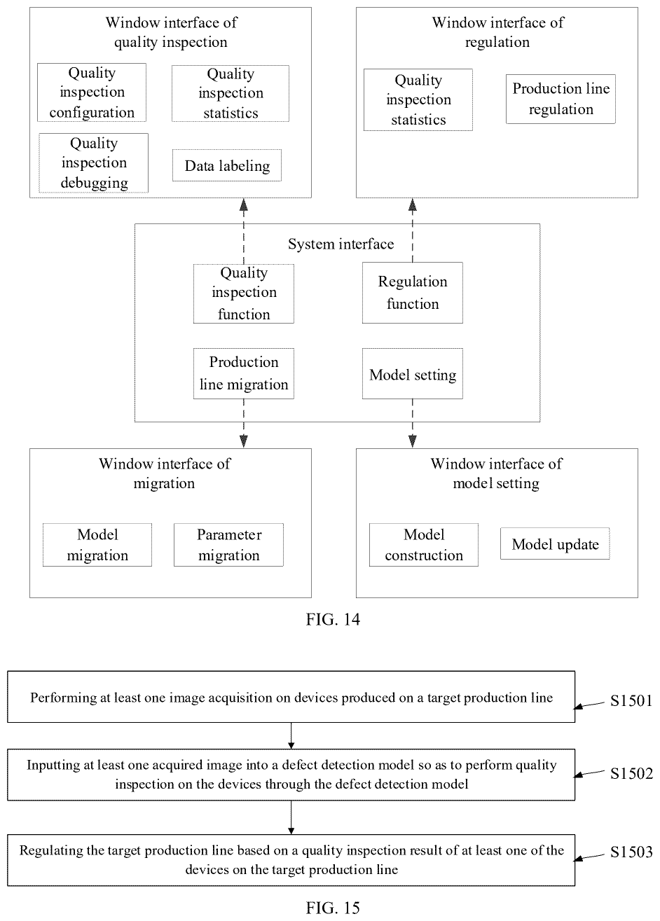

Based on the same inventive concept, the present disclosure also provides a quality control method. The quality control method may be solidified into a computer-readable storage medium and configured on a computer device to perform the quality control. Specifically, FIG. 15 is a flow chart showing the steps of a quality control method for a production line according to the present disclosure. As shown in FIG. 15, the method may specifically include the following steps:

Step S1501: Performing at least one image acquisition on to-be-inspected objects produced on a target production line.

Step S1502: Inputting at least one acquired image into a defect detection model so as to perform the quality inspection on the to-be-inspected objects through the defect detection model.

Step S1503: Regulating the target production line based on a quality inspection result of at least one of the to-be-inspected objects on the target production line.

In this embodiment, at least one image acquisition of the to-be-inspected object produced on the target production line may be started in response to online running of the target production line. An image acquisition apparatus may perform acquisition at a pre-configured acquisition frequency and resolution during the image acquisition.

The quality inspection of the to-be-inspected objects by the defect detection model may be carried out by referring to the description of the above-mentioned embodiments, and will not be described in detail.

The target production line may be regulated at preset intervals according to the quality inspection results of the to-be-inspected objects subjected to quality inspection, or the automatic regulation of the target production line may be triggered when the number of the to-be-inspected objects which have failed the quality inspection exceeds a preset number.

During the regulation, the quality inspection results may be statistically analyzed according to the time period of production and the distribution of the defect positions. In general, when the quality inspection results are statistically analyzed according to the time period of production, it may be determined which time period of production has more to-be-inspected objects which have failed the quality inspection, and which time period of production has less to-be-inspected objects which have failed the quality inspection, so that it may be determined that the target production line is liable to have a failure in the process flow at some time period, thereby regulating the process flow at the time period accordingly. When performing statistical analysis according to the distribution of the defect positions, it may be determined which position of the to-be-inspected object has more defects and which position has less defects. Generally, the defect position is related to the production of the to-be-inspected object in the target production line. For example, when cutting the display substrate, if the statistical analysis result of the defect position shows that a greater number of the to-be-inspected objects which have failed the defect detection at an upper left corner of the display substrate, a cutting process device corresponding to the upper left corner needs to be debugged.

Thus, the target production line may be regulated according to the statistical analysis result of the time period of production of the to-be-inspected objects and/or the distribution of the defect positions. When debugging, the process flow corresponding to the time period of production, when the number of the to-be-inspected objects which have failed the quality inspection is greater, may be regulated according to the statistical analysis result, and the process flow corresponding to the position, where the number of the to-be-inspected objects which have failed the defect detection is greater, may be regulated, so that the quality inspection of the to-be-inspected objects may be fed back to the target production line to regulate the target production line. Therefore, the target production line may be continuously maintained at a higher quality process. As a result, the quality level of the to-be-inspected objects produced thereby is improved, thereby improving the quality control level of the target production line.

With this implementation, the quality inspection is performed on the to-be-inspected objects on the target production line, and the target production line is regulated according to the quality inspection, whereby the quality inspection on the to-be-inspected objects in the present disclosure may be deeply implemented into a production line for producing the to-be-inspected objects, so as to regulate the process flow and the like of the production line in combination with the quality inspection condition of the to-be-inspected objects. Therefore, the yield problem of the to-be-inspected objects can be solved from the source of producing the to-be-inspected objects, such as process parameters and process devices, and the production cost consumed due to the abandonment of the to-be-inspected objects with poor quality can be reduced. On the other hand, since the target production line may be regulated according to the statistical analysis results of the quality inspection results in the time period of production and the defect position, the target production line may be regulated in a targeted manner and the regulation efficiency can be improved.

In some embodiments, when performing image acquisition, the image acquisition may be performed according to preset configuration parameters, and the quality inspection may be performed on the to-be-inspected objects through the defect detection model according to preset threshold parameters corresponding to the defect detection model.

Accordingly, a configuration parameter corresponding to the target production line may be obtained. The configuration parameter includes a working parameter of a device for the quality inspection and a threshold parameter of the defect detection model.

When performing at least one image acquisition on the to-be-inspected objects produced on the target production line, at least one image acquisition may be performed on the to-be-inspected objects based on the working parameter.

When inputting at least one acquired image into the defect detection model to perform the quality inspection on the to-be-inspected objects through the defect detection model, the at least one acquired image may be inputted into the defect detection model, and the defect detection model is instructed to perform the quality inspection on the to-be-inspected objects based on the threshold parameter.

In this embodiment, the configuration parameters may be configuration parameters migrated from other production lines associated with the target production line or configuration parameters pre-stored and associated to the target production line. As such, the process of performing image acquisition based on the configuration parameters and defect detection based on the threshold parameters of the defect detection model may be described with reference to the above-mentioned embodiments, and will not be described in detail herein.

In some embodiments, as described above, the working parameters of the industrial control device may be adjusted during the quality inspection based on the efficiency of the quality inspection and the defect position, and image acquisition parameters may be adjusted in time, so as to achieve real-time adjustment of information acquisition required for the quality inspection.

Specifically, a first position and a second position may be determined according to a defect position distribution of the plurality of to-be-inspected objects in the process of the quality inspection. The number of the to-be-inspected objects having a defect at the first position exceeds a first preset number, the number of the to-be-inspected objects having a defect at the second position does not exceed a second preset number, and the first preset number is greater than the second preset number.

The image acquisition parameter includes an acquisition frequency and/or an acquisition resolution.

In this embodiment, the configuration parameters may be automatically updated based on the quality inspection results of the to-be-inspected objects in the quality inspection. Specifically, the first position and the second position may be determined based on the defect position distribution of a plurality of to-be-inspected objects.

The first position will also be understood to be: a position at which the number of the to-be-inspected objects which have passed the defect detection within a unit time exceeding the first preset number. The second position will also be understood to be: a position at which the number of the to-be-inspected objects which shave failed the defect detection within a unit time exceeding the second preset number. Thus, the first position may refer to a position where defects are less frequent, and the second position may refer to a position where defects are more frequent. The first position may be different from the second position.

It should be noted that there may be more than one first position and more than one second position.

Thus, the quality control system may target the image acquisition parameters of the device. As described in the above-mentioned embodiments, the working parameter may include a working parameter of the image acquisition apparatus and a working parameter of the controller. The working parameter of the controller is used for indicating a start position and an end position when the image acquisition apparatus performs the image acquisition, and a movement rate between the start position and the end position. The working parameter of the image acquisition apparatus is used for indicating an acquisition frequency and resolution of the image acquisition. Thus, the working parameters may be adjusted based on the first position and the second position in the following adjustment manners:

Firstly, since the first position is a position where defects are less frequent, it is thus possible to increase the movement rate of the camera at this position. That is, the camera may not perform refinement acquisition on this position. Specifically, a preset value may be reduced at the current movement rate of the image acquisition apparatus, and the acquisition frequency of the image acquisition apparatus at this position may be reduced, so as to reduce the number of images acquired at this position by the image acquisition apparatus. Specifically, the preset value may be reduced at the current acquisition frequency of the image acquisition apparatus. Certainly, it is possible to reduce the acquisition resolution of the image acquisition apparatus at this position, for example, to reduce a preset resolution level at the current acquisition resolution.

Since the second position is a position where defects are more frequent, it is thus possible to reduce the movement rate of the camera at this position. That is, the camera may perform the refinement acquisition on the position. Specifically, a preset value may be increased at the current movement rate of the image acquisition apparatus, and the acquisition frequency of the image acquisition apparatus at this position may be increased, so as to increase the number of images acquired at this position by the image acquisition apparatus. Specifically, the preset value may be increased at the current acquisition frequency of the image acquisition apparatus. Certainly, it is possible to increase the acquisition resolution of the image acquisition apparatus at this position, for example, to increase a preset resolution level at the current acquisition resolution, so as to realize rough inspection on the first position and fine detection on the second position, thereby saving resources.

The adjustment of the working parameters at the first position and the second position may be performed alternatively or entirely, and is not limited thereto.

Accordingly, when the quality inspection process is adjusted according to the quality inspection result, the quality inspection control system may automatically adjust the working parameters of the industrial control device according to the quality inspection result.

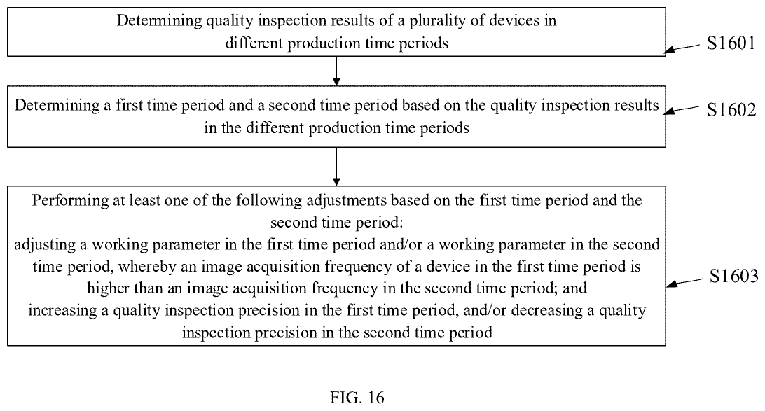

In still other embodiments, FIG. 16 is a flow chart showing the steps of adjusting a quality inspection process in real time. As shown in FIG. 16, the flow may specifically include the following steps:

Step S1601: Determining quality inspection results of a plurality of to-be-inspected objects in different production time periods.

Step S1602: Determining a first time period and a second time period based on the quality inspection results in the different production time periods, where the quality inspection passing rate of the to-be-inspected objects produced in the first time period is lower than the quality inspection passing rate of the to-be-inspected objects produced in the second time period.

In this embodiment, the quality inspection passing rate of the to-be-inspected objects produced in the first time period is lower than the quality inspection passing rate of the to-be-inspected objects produced in the second time period, which means that: the number of the to-be-inspected objects which are produced in the first time period and have failed the quality inspection is greater than a third preset number, and the number of the to-be-inspected objects which are produced in the second time period and have failed the quality inspection is less than a fourth preset number. The third preset number is greater than the fourth preset number.

In practice, the time periods of production may be divided according to requirements, which will not be described in detail herein. At the end of a statistical period, such as a week and a day, it is possible to start to perform statistics on the quality inspection results of a plurality of to-be-inspected objects in different time periods of production, so as to obtain the quality inspection passing rate of the to-be-inspected objects in each time period of production.

Next, different time periods may be sorted according to the descending or ascending order of the quality inspection passing rate, so as to obtain a first time period with a lower quality inspection passing rate and a second time period with a higher quality inspection passing rate.

The first time period and the second time period may certainly be determined according to the quality inspection passing rate of a plurality of statistical periods. For example, in time period 1, if a plurality of statistical periods all show that the passing rate of the time period 1 is low, the time period 1 is taken as the first time period, and if only one statistical period shows that the passing rate is low, the time period 1 may not be taken as the first time period. The second time period may also be determined based on the determination of the first time period.

Step S1603: Performing at least one of the following adjustments based on the first time period and the second time period:
adjusting a working parameter in the first time period and/or a working parameter in the second time period, whereby an image acquisition frequency of a device in the first time period is higher than an image acquisition frequency in the second time period; and
increasing a quality inspection precision in the first time period, and/or decreasing a quality inspection precision in the second time period.

In practice, the first time period may refer to a time period where defects of the to-be-inspected objects are more frequent, and in practice, problems occur in the process flow characterizing the time period or the operation of a worker on the target production line thereof. Therefore, in this time period, working parameters may be adjusted in a targeted manner. Specifically, as similar to the above-mentioned regulation mode for the defect positions, in this time period, the image acquisition frequency of the device may be appropriately increased. Specifically, a preset value may be increased on the current image acquisition frequency. In the second time period, the image acquisition frequency of the device may be reduced. Specifically, a preset value may be reduced on the current image acquisition frequency, so as to realize fine inspection for the first time period and rough inspection for the second time period, thereby saving resources.

At the same time, the quality inspection precision of the first time period and the quality inspection precision of the second time period may also be adjusted. The quality inspection precision may be aimed at the defect detection model. In practice, the quality inspection precision of the first time period may be increased, and the quality inspection precision of the second time period may be reduced, so as to realize strict quality inspection on the first time period and rough inspection on the second time period, thereby saving resources and improving efficiency.

In some embodiments, the target production line may be regulated according to the quality inspection result. Specifically, when debugging, statistics may be performed on the quality inspection result according to the defect positions of the to-be-inspected objects, the number distribution of the to-be-inspected objects which have failed the quality inspection in different time periods, and the defect type. The target production line may then be regulated according to the statistical result.

In a specific implementation, statistics may be performed on the quality inspection results of a plurality of to-be-inspected objects according to the defect position, and/or statistics may be performed on the quality inspection results of a plurality of to-be-inspected objects according to the time period of production. Next, the process device corresponding to the defect position on the target production line is regulated based on the statistical result of the defect position and/or the statistical result of the detection time period during which the defect occurs.

The regulation in this embodiment may be described with reference to the above-mentioned embodiments of the quality control method, and will not be described in detail herein.

Certainly, in some embodiments, when performing statistics on the quality inspection results, statistics may be performed on the quality inspection results of a plurality of to-be-inspected objects according to the defect position and/or the detection time period. The statistical result is generated into a statistical chart according to a preset icon mode, and the statistical chart is displayed. The preset icon mode includes a pie chart, a bar chart, a line chart a thermodynamic chart, and the like.

The statistics and chart generation method in this embodiment may be described with reference to the above-mentioned embodiments of the quality control method, and will not be described in detail herein.

Accordingly, the target production line may be regulated based on a statistical chart. Specifically, quality inspection information corresponding to a chart region may be determined in response to triggering the chart region in the statistical chart. Debugging parameters corresponding to the quality inspection information are obtained from a database, and the process device on the target production line is regulated based on the debugging parameters.

The quality inspection information includes at least one of a target defect position, a target time period, and a target defect type, where the number of the to-be-inspected objects having a defect at the target defect position exceeds a first preset number, the number of the to-be-inspected objects failing to pass quality inspection in the target time period exceeds a second preset number, and the number of the to-be-inspected objects having a defect of the target defect type exceeds a third preset number.

The database stores debugging parameters corresponding to the plurality of quality inspection information.

The regulation for the quality inspection information in this embodiment may be described with reference to the above-mentioned embodiments of the quality control method, and will not be described in detail herein.

Certainly, in still other embodiments, the defect detection model may be updated. The condition triggering the update of the defect detection model may be: if a preset number (for example, 10,000) of to-be-inspected objects have been subjected to the quality inspection, the update of the defect detection model may be triggered when 10,000 to-be-inspected objects have been subjected to the quality inspection.

In a specific implementation, when updating the defect detection model, a second data set may be obtained, and according to the description of the embodiment of the above-mentioned quality control method, the defect detection model is updated by using the second data set. Next, the defect detection model subjected to the quality inspection at the current time may be replaced with the updated defect detection model.

The technical solution of this embodiment achieves the following advantages:

On the one hand, the quality inspection is performed on the to-be-inspected objects on a target production line, and the target production line is regulated according to the quality inspection, whereby the quality inspection on the to-be-inspected objects in the present disclosure may be deeply implemented into a production line for producing the to-be-inspected objects, so as to regulate the process flow and the like of the production line in combination with the quality inspection condition of the to-be-inspected objects. Therefore, the yield problem of the to-be-inspected objects can be solved from the source of producing the to-be-inspected objects, such as process parameters and process devices, and the production cost consumed due to the abandonment of the to-be-inspected objects with poor quality can be reduced.

On another hand, since the target production line may be regulated according to the statistical analysis results of the quality inspection results in the time period of production and the defect position, the target production line may be regulated in a targeted manner and the regulation efficiency can be improved.

On yet another hand, according to the quality inspection result, a position and a time period of production where defects are more frequent, and a position and a time period of production where defects are less frequent may be determined, so as to be fed back to a device for the quality inspection, and the precision of the image acquisition and the defect detection in the quality inspection may be adjusted according to the positions and the time periods of production, thereby fully saving resources, whereby hardware resources of the production line can fully focus on the positions and time periods of the to-be-inspected objects, which achieves the rational use of resources and improves the efficiency.

In view of the above-mentioned quality control method according to Embodiment 2, there are the following advantages:
1. An interface visualization and low technical threshold training scheme of an AI model for industrial quality inspection is provided, and core functions of data labeling, model training, and model publishing in the development of quality inspection scene models are integrated, thereby greatly reducing the technical threshold and research and development efficiency for training quality inspection models by the departments with weak AI technology accumulation, such as factories and production lines, by using AI technology.
2. Unified management functions for employees, devices, and data are provided, and permission management is provided for employees with different posts in the terms of employee management, so as to assist the reliable implementation of a production line management system. In terms of device management, the present disclosure supports the integrated management of devices such as a PLC, an industrial control server, a data server, an industrial camera, and a trigger, mainly including: device asset management, device state monitoring, policy issuing, and the like, may also perform data management, including data statistics, data analysis, data retrieval, data storage, data labeling, multi-terminal presentation, and the like.
3. The training iteration of an algorithm model (defect detection model) and a real machine debugging environment of an industrial control device are supported, so as to facilitate the real machine debugging of research and development and maintenance personnel and improve the research and development efficiency.
4. According to the conventional service requirements of an industrial production line, it is divided into three parts: a quality inspection terminal, a control terminal, and an automatic training. By disassembling the whole system into a plurality of modules, relative decoupling of quality inspection, start-up, and research and development of production lines is realized, and the space and flexibility of future function expansion are improved.
5. In the automatic training part, the threshold may be lowered through various configuration options. At the quality inspection terminal, the core functions of industrial control device configuration, algorithm configuration, material configuration, workbench detection, and device monitoring directly used in the first-line quality inspection scenario are integrated for a detection server on the production line, and communication with a digital server for the transmission of production and running data is performed. At the regulation terminal, as a central management node of the whole system, is configured with the functions of big data processing, storage, analysis, and device management, covering the functions of data management, detection device management, user management, and data analysis.
6. In addition, the quality control system supports data communication with an industrial production system, thereby realizing data sharing and promoting the digitization of the whole production process.

Based on the same inventive concept, the present disclosure also provides a quality control apparatus for a production line. The apparatus may include the following modules:
a quality inspection module configured to, in response to triggering of a first preset condition, perform quality inspection on a plurality of to-be-inspected objects produced on a
a feedback module configured to feed back a result of the quality inspection to a control object associated with the target production line, the control object being used for controlling a process flow of the target production line; and
a regulation module configured to, in response to a second preset condition triggered on the control object, regulate the target production line based on a quality inspection result of at least one to-be-inspected object.

The quality inspection includes: performing at least one image acquisition on the to-be-inspected objects produced by the target production line, and inputting at least one acquired image into a defect detection model, so as to perform the quality inspection on the to-be-inspected objects.

Optionally, the first preset condition includes: starting operation of the target production line, and/or a quality inspection function triggered on a preset interface.

Optionally, the second preset condition includes: the number of the to-be-inspected objects that fail the quality inspection being greater than or equal to a preset number, and/or preset operations triggered on the control object.

Optionally, the apparatus further includes:
a first interface display module configured to, before performing quality inspection on a plurality of to-be-inspected objects produced on a target production line, display a first configuration interface in response to a triggered quality inspection configuration function, where the first configuration interface includes a first configuration item of a device for quality inspection and a second configuration item of the defect detection model; and
a parameter receiving module, configured to receive configuration parameters respectively inputted through the first configuration item and the second configuration item.

The performing quality inspection on a plurality of to-be-inspected objects produced on a target production line specifically includes: performing the quality inspection on the plurality of to-be-inspected objects produced on the target production line based on the configuration parameters.

Optionally, the apparatus further includes:
a second interface display module configured to, in response to a triggered quality inspection debugging function, display a second configuration interface, where the second configuration interface includes a target configuration item, the target configuration item includes a first configuration item of a device for quality inspection and/or a second configuration item of the defect detection model; and
a result display module configured to display a statistical result about statistics on quality inspection results of the to-be-inspected objects subjected to quality inspection on the second configuration interface, and record a configuration parameter modified from a current configuration parameter of the target configuration item.

The step of performing quality inspection on a plurality of to-be-inspected objects produced on a target production line includes: performing the quality inspection on the plurality of to-be-inspected objects produced on the target production line after the current time based on the modified configuration parameter.

Optionally, the device for quality inspection includes an image acquisition apparatus and a controller for controlling the movement of the image acquisition apparatus, and the first configuration item is used for inputting working parameters respectively corresponding to the image acquisition apparatus and the controller.

The working parameter corresponding to the image acquisition apparatus includes an acquisition frequency and/or an acquisition resolution, and the working parameter corresponding to the controller includes at least one of a start position, an end position, and a movement rate of the image acquisition apparatus.

Optionally, the second configuration item is used for inputting a threshold parameter corresponding to the defect detection model and/or for inputting a working parameter of a server on which the defect detection model is located.

Optionally, the apparatus further includes:
an association module configured to, when it is detected that an associated production line associated with the target production line is running, in response to a triggered parameter migration function, associate the configuration parameters to the associated production line, where defects of the to-be-inspected objects targeted by the quality inspection in the associated production line are the same as or similar to defects of the to-be-inspected objects targeted by the quality inspection in the target production line; and
an associated quality inspection module configured to perform the quality inspection on the plurality of to-be-inspected objects produced on the associated production line by using the defect detection model based on the configuration parameters.

Optionally, the apparatus further includes:
a target parameter set obtaining module configured to obtain a target data set corresponding to the associated production line, the target data set including image samples after image acquisition and labeling on the plurality of to-be-inspected objects on the associated production line; and
an update module configured to, in response to a triggered model migration function, update the defect detection model by using the target data set to obtain a migration model.

The associated quality inspection module is specifically configured to perform the quality inspection on the plurality of to-be-inspected objects produced on the associated production line by using the migration model based on the configuration parameters.

Optionally, the apparatus further includes:
a third interface display module configured to, in response to a triggered model construction function, display a third configuration interface, where the third configuration interface includes at least one trigger control, different trigger controls being used for triggering different configuration windows in a model construction process;
an option determination module configured to determine configuration options selected in different configuration windows, where the configuration window includes a plurality of configuration options; and
an automatic training module configured to, based on preset configuration parameters corresponding to the selected configuration options, obtain the defect detection model through training by using a pre-stored first data set as a training sample.

Optionally, the apparatus further includes:
a data set obtaining module, configured to obtain a second data set in response to a triggered model update function, where the second data set includes a plurality of target image samples, the target image samples includes regions for re-labeling defect regions of the to-be-inspected objects subjected to the quality inspection; and
a module update module, configured to update the defect detection model by using the second data set as a training sample, and replace the defect detection model performing the quality inspection at the current time with an updated defect detection model.

Optionally, the second data set is obtained by:
in response to a triggered data labeling function, obtaining a plurality of quality inspection results of the plurality of to-be-inspected objects subjected to the quality inspection, and displaying the plurality of quality inspection results;
in response to an error correction operation triggered for a target quality inspection result among the plurality of quality inspection results, displaying at least one target image corresponding to the target quality inspection result, the target image being marked with a defect region;
labeling a modified defect region on the target image in response to a modification operation for the defect region; and
adding a target image labeled with the modified defect region as the target image sample to the second data set.

Optionally, the quality inspection includes quality inspection on a plurality of defect types of the to-be-inspected objects. The defect detection model includes detection branches corresponding to the plurality of defect types. The model update module includes:
a type determination unit configured to, in response to a selection operation on at least one defect type among the plurality of defect types, obtain a labeling subset corresponding to the selected defect type from the second data set, a labeled defect region of a target image sample in the labeling subset corresponding to the selected defect type; and
an update unit, configured to update the detection branch corresponding to the selected defect type in the defect detection model by using the labeling subset.

Optionally, the feedback module includes:
a statistical unit configured to, in response to a triggered quality inspection statistics function, perform statistics on the quality inspection results of the plurality of to-be-inspected objects to obtain a statistical result;
a chart generation unit, configured to generate a statistical chart based on the statistical result; and
a chart sending unit, configured to send the statistical chart to the control object, where the statistical chart includes at least one of a pie chart, a bar chart, a line chart, and a thermodynamic chart.

Optionally, the statistical unit includes at least one of the following:
a first statistical subunit, configured to perform statistics on the quality inspection results of the plurality of to-be-inspected objects according to positions where defects occur;
a second statistical subunit, configured to perform statistics on the quality inspection results of the plurality of to-be-inspected objects according to a time period in which the to-be-inspected objects are produced; and
a third statistical subunit, configured to perform statistics on the quality inspection results of the plurality of to-be-inspected objects according to the types of the defects, where the quality inspection is used for detecting a plurality of defect types of the to-be-inspected objects.

Optionally, the regulation module includes:
an information display unit configured to, when the second preset condition is a preset operation triggered on the control object, display quality inspection information in response to the preset operation, the quality inspection information including at least one of a target defect position, a target time period, and a target defect type, where the number of the to-be-inspected objects having a defect at the target defect position exceeds a first preset number, the number of the to-be-inspected objects failing to pass quality inspection in the target time period exceeds a second preset number, and the number of the to-be-inspected objects having a defect of the target defect type exceeds a third preset number;
a debugging parameter receiving unit, configured to receive a debugging parameter entered for the quality inspection information, the debugging parameter including a working parameter of a process device on the target production line; and
a regulation unit, configured to regulate the process device based on the debugging parameter.

Optionally, the defect detection model includes a first model and a second model. The quality inspection module includes:
a first quality inspection unit, configured to input the at least one acquired image into the first model so as to perform a first quality inspection on the to-be-inspected objects; and
a second quality inspection unit configured to, when a result of the first quality inspection indicates that the quality inspection fails, re-perform at least one image acquisition on the to-be-inspected objects, and input the re-acquired image into the second model so as to perform a second quality inspection on the to-be-inspected objects.

The quality inspection precision of the first quality inspection is less than the quality inspection precision of the second quality inspection.

Optionally, the apparatus further includes:
a number determination module configured to, in the process of performing the quality inspection on the plurality of to-be-inspected objects produced on the target production line, determine the number of the to-be-inspected objects of which the quality inspection is completed within a unit time; and
a speed adjustment module configured to adjust a conveying speed of the to-be-inspected objects on the target production line based on the number.

Based on the same inventive concept, the present disclosure also provides a quality control apparatus for a production line. The apparatus may include the following modules:
an image acquisition module, configured to perform at least one image acquisition on to-be-inspected objects produced on a target production line;
a quality inspection module, configured to input at least one acquired image into a defect detection model so as to perform quality inspection on the to-be-inspected objects through the defect detection model; and
a regulation module, configured to regulate the target production line based on a quality inspection result of at least one of the to-be-inspected objects on the target production line.

Optionally, the apparatus further includes:
a configuration parameter obtaining module, configured to obtain a configuration parameter corresponding to the target production line, the configuration parameter including a working parameter of a device for quality inspection and a threshold parameter of the defect detection model.

The image acquisition module includes:
an acquisition unit, configured to perform at least one image acquisition on the to-be-inspected objects based on the working parameter.

The step of inputting at least one acquired image into a defect detection model so as to perform quality inspection on the to-be-inspected objects through the defect detection model includes: inputting the at least one acquired image into the defect detection model, and instructing the defect detection model to perform quality inspection on the to-be-inspected objects based on the threshold parameter.

Optionally, the quality inspection result includes a defect position of the to-be-inspected object. The apparatus further includes:
a position determination module configured to, after the inputting at least one acquired image into a defect detection model so as to perform quality inspection on the to-be-inspected objects through the defect detection model, determine a first position and a second position according to a defect position distribution of the plurality of to-be-inspected objects, where the number of the to-be-inspected objects having a defect at the first position exceeds a first preset number, the number of the to-be-inspected objects having a defect at the second position does not exceed a second preset number, and the first preset number is greater than the second preset number; and
a parameter update module, configured to update the working parameter based on the first position and the second position, so that an image acquisition parameter of the device at the first position is lower than an image acquisition parameter at the second position, where the image acquisition parameter includes an acquisition frequency and/or an acquisition resolution.

Optionally, the apparatus further includes:
a quality inspection result determination module, configured to determine quality inspection results of a plurality of to-be-inspected objects in different production time periods;
a time period determination module, configured to determine a first time period and a second time period based on the quality inspection results in the different production time periods, where a quality inspection passing rate of the to-be-inspected objects produced in the first time period is lower than a quality inspection passing rate of the to-be-inspected objects produced in the second time period; and
an adjustment module, configured to perform at least one of the following adjustments based on the first time period and the second time period:
adjusting a working parameter in the first time period and/or a working parameter in the second time period, so that an image acquisition frequency of the device in the first time period is higher than an image acquisition frequency in the second time period; and
increasing a quality inspection precision in the first time period, and/or decreasing a quality inspection precision in the second time period.

Based on the same inventive concept, the present disclosure also provides an electronic device including a memory, a processor, and a computer program stored on the memory and executable on the processor. When the computer program is executed by the processor, the quality control method for the production line according to the embodiments is implemented.

Embodiments of the present disclosure also provide a computer-readable storage medium storing a computer program for causing a processor to perform the quality control method for the production line according to the embodiments of the present disclosure.

Finally, it should be noted that in this specification, relational terms such as first and second are only used to distinguish one entity or operation from another entity or operation, and do not necessarily require or imply any actual relationship or order between these entities or operations. Moreover, the terms “including”, “comprising”, or any other variation thereof are intended to encompass non-exclusive inclusion, such that a process, method, commodity, or device that includes a series of elements not only includes those elements, but also includes other elements that are not explicitly listed, or also includes elements inherent to such process, method, commodity, or device. Without further limitations, the elements limited by the statement “including one . . . ” do not exclude the existence of other identical elements in the process, method, commodity, or device that includes the said elements.

The above provides a detailed introduction to the quality control methods, systems, and manufacturing platforms of the production line provided in the present disclosure. Specific examples are applied in this specification to explain the principles and implementation methods of the present disclosure. The above examples are only used to help understand the methods and core ideas of the present disclosure. Meanwhile, for persons skilled in the art, there may be changes in specific implementation methods and application scope based on the ideas disclosed in the present disclosure. In summary, the content of this manual should not be understood as a limitation on the present disclosure.

Persons skilled in the art, after considering the specification and practicing the invention disclosed herein, will easily come up with other embodiments of the present disclosure. The present disclosure aims to cover any variations, uses, or adaptive changes of the present disclosure, which follow the general principles of the present disclosure and include common knowledge or customary technical means in the field of technology that are not disclosed in the present disclosure. The specification and embodiments are only considered exemplary, and the true scope and spirit of the present disclosure are indicated by the following claims.

It should be understood that the present disclosure is not limited to the precise structure described above and shown in the drawings, and various modifications and changes can be made without departing from its scope. The scope of the present disclosure is limited only by the attached claims.

The term “one embodiment,” “embodiment,” or “one or more embodiments” referred to in this specification means that specific features, structures, or features described in conjunction with the embodiments are included in at least one embodiment of the present disclosure. Furthermore, please note that the example of the term “in one embodiment” may not necessarily refer to the same embodiment.

In the specification provided here, a large number of specific details are explained. However, it can be understood that the embodiments of the present disclosure can be practiced without these specific details. In some examples, well-known methods, structures, and techniques are not shown in detail to avoid blurring the understanding of this specification.

In the claims, any reference symbol between parentheses should not be constructed as a limitation on the claims. The word “comprising” does not exclude the presence of components or steps not listed in the claims. The word “a/an” or “one” before a component does not exclude the existence of multiple such components. The present disclosure can be achieved through hardware comprising several different components and through appropriately programmed computers. Among the unit claims that list several devices, several of these devices can be specifically embodied through the same hardware item. The use of words such as first, second, and third does not indicate any order. These words can be interpreted as names.

Finally, it should be noted that the above embodiments are only used to illustrate the technical solution of the present disclosure, and not to limit it. Although detailed explanations of the present disclosure have been provided with reference to the aforementioned embodiments, those skilled in the art should understand that they can still modify the technical solutions recorded in the aforementioned embodiments, or equivalently replace some of the technical features therein. And these modifications or replacements do not make the essence of the corresponding technical solutions deviate from the spirit and scope of the technical solutions disclosed in the present disclosure.

1. A quality control method for a production line, wherein the method comprises:
in response to triggering of a first preset condition, performing quality inspection on a plurality of to-be-inspected objects produced on a target production line;
feeding back a result of the quality inspection to a control object associated with the target production line, wherein the control object is used for controlling a process flow of the target production line; and
in response to a second preset condition triggered on the control object, regulating the target production line based on a quality inspection result of at least one to-be-inspected object;
wherein the quality inspection comprises: performing at least one image acquisition on the to-be-inspected objects produced by the target production line, and inputting at least one acquired image into a defect detection model, so as to perform the quality inspection on the to-be-inspected objects.

2. The quality control method according to claim 1, wherein the first preset condition comprises: starting operation of the target production line, and/or a quality inspection function triggered on a preset interface.

3. The quality control method according to claim 1, wherein the second preset condition comprises: a number of the to-be-inspected objects that fail the quality inspection being greater than or equal to a preset number, and/or preset operations triggered on the control object.

4. The quality control method according to claim 1, wherein before performing quality inspection on a plurality of to-be-inspected objects produced on a target production line, the method further comprises:
in response to a triggered quality inspection configuration function, displaying a first configuration interface, wherein the first configuration interface comprises a first configuration item of a device for the quality inspection and a second configuration item of the defect detection model; and
receiving configuration parameters respectively inputted through the first configuration item and the second configuration item; and
the performing quality inspection on a plurality of to-be-inspected objects produced on a target production line comprises:
performing the quality inspection on the plurality of to-be-inspected objects produced on the target production line based on the configuration parameters.

5. The quality control method according to claim 1, wherein in a process of performing the quality inspection on the plurality of to-be-inspected objects produced on the target production line, the method further comprises:
in response to a triggered quality inspection debugging function, displaying a second configuration interface, wherein the second configuration interface comprises a target configuration item, the target configuration item comprises a first configuration item of a device for the quality inspection and/or a second configuration item of the defect detection model; and
displaying a statistical result about statistics on quality inspection results of the to-be-inspected objects subjected to quality inspection on the second configuration interface, and recording a configuration parameter modified from a current configuration parameter of the target configuration item; and
the performing quality inspection on a plurality of to-be-inspected objects produced on a target production line comprises:
performing the quality inspection on the plurality of to-be-inspected objects produced on the target production line after a current time based on the modified configuration parameter.

6. The quality control method according to claim 4, wherein the device for the quality inspection comprises an image acquisition apparatus and a controller for controlling movement of the image acquisition apparatus, and the first configuration item is used for inputting working parameters respectively corresponding to the image acquisition apparatus and the controller;
wherein the working parameter corresponding to the image acquisition apparatus comprises an acquisition frequency and/or an acquisition resolution, and the working parameter corresponding to the controller comprises at least one of a start position, an end position, and a movement rate of the image acquisition apparatus.

7. The quality control method according to claim 4, wherein the second configuration item is used for inputting a threshold parameter corresponding to the defect detection model and/or for inputting a working parameter of a server on which the defect detection model is located.

8. The quality control method according to claim 4, further comprising:
when it is detected that an associated production line associated with the target production line is running, in response to a triggered parameter migration function, associating the configuration parameters to the associated production line, wherein defects of the to-be-inspected objects targeted by the quality inspection in the associated production line are the same as or similar to defects of the to-be-inspected objects targeted by the quality inspection in the target production line; and
performing the quality inspection on the plurality of to-be-inspected objects produced on the associated production line by using the defect detection model based on the configuration parameters.

9. The quality control method according to claim 8, wherein before performing the quality inspection on the plurality of to-be-inspected objects produced on the associated production line by using the defect detection model based on the configuration parameters, the method further comprises:
obtaining a target data set corresponding to the associated production line, wherein the target data set comprises image samples after image acquisition and labeling on the plurality of to-be-inspected objects on the associated production line; and
in response to a triggered model migration function, updating the defect detection model by using the target data set to obtain a migration model; and
the performing the quality inspection on the plurality of to-be-inspected objects produced on the associated production line by using the defect detection model based on the configuration parameters comprises:
performing the quality inspection on the plurality of to-be-inspected objects produced on the associated production line by using the migration model based on the configuration parameters.

10. The quality control method according to claim 1, wherein before the step of performing quality inspection on a plurality of to-be-inspected objects produced on a target production line, the method further comprises:
in response to a triggered model construction function, displaying a third configuration interface, wherein the third configuration interface comprises at least one trigger control, and different trigger controls are used for triggering different configuration windows in a model construction process;
determining configuration options selected in different configuration windows, wherein each of the configuration window comprises a plurality of configuration options; and
based on preset configuration parameters corresponding to the selected configuration options, obtaining the defect detection model through training by using a pre-stored first data set as a training sample.

11. The quality control method according to claim 1, wherein after performing quality inspection on a plurality of to-be-inspected objects produced on a target production line, the method further comprises:
obtaining a second data set in response to a triggered model update function, wherein the second data set comprises a plurality of target image samples, and the target image samples comprises regions for re-labeling defect regions of the to-be-inspected objects subjected to the quality inspection;
updating the defect detection model by using the second data set as a training sample; and
replacing the defect detection model performing the quality inspection at a current time with an updated defect detection model.

12. The quality control method according to claim 11, wherein the second data set is obtained by:
in response to a triggered data labeling function, obtaining a plurality of quality inspection results of the plurality of to-be-inspected objects subjected to the quality inspection, and displaying the plurality of quality inspection results;
in response to an error correction operation triggered for a target quality inspection result among the plurality of quality inspection results, displaying at least one target image corresponding to the target quality inspection result, wherein the target image is marked with a defect region;
labeling a modified defect region on the target image in response to a modification operation for the defect region; and
adding a target image labeled with the modified defect region as the target image sample to the second data set.

13. The quality control method according to claim 11, wherein the quality inspection comprises quality inspection on a plurality of defect types of the to-be-inspected objects, the defect detection model comprises detection branches corresponding to the plurality of defect types, and the updating the defect detection model by using the second data set as a training sample comprises:
in response to a selection operation on at least one defect type among the plurality of defect types, obtaining a labeling subset corresponding to the selected defect type from the second data set, wherein a labeled defect region of the target image sample in the labeling subset corresponds to the selected defect type; and
updating the detection branch corresponding to the selected defect type in the defect detection model by using the labeling subset.

14. The quality control method according to claim 1, wherein the feeding back a result of the quality inspection to a control object associated with the target production line comprises:
in response to a triggered quality inspection statistics function, performing statistics on quality inspection results of the plurality of to-be-inspected objects to obtain a statistical result;
generating a statistical chart based on the statistical result; and
sending the statistical chart to the control object, wherein the statistical chart comprises at least one of a pie chart, a bar chart, a line chart, and a thermodynamic chart.

15. The quality control method according to claim 14, wherein the performing statistics on quality inspection results of the plurality of to-be-inspected objects comprises at least one of the following:
performing statistics on the quality inspection results of the plurality of to-be-inspected objects according to positions where defects occur;
performing statistics on the quality inspection results of the plurality of to-be-inspected objects according to a time period in which the to-be-inspected objects are produced; and
performing statistics on the quality inspection results of the plurality of to-be-inspected objects according to types of the defects, wherein the quality inspection is used for detecting a plurality of defect types of the to-be-inspected objects.

16. The quality control method according to claim 1, wherein the in response to a second preset condition triggered on the control object, regulating the target production line based on a quality inspection result of at least one to-be-inspected object comprises:
when the second preset condition is a preset operation triggered on the control object, displaying quality inspection information in response to the preset operation, the quality inspection information comprising at least one of a target defect position, a target time period, and a target defect type, wherein a number of the to-be-inspected objects having a defect at the target defect position exceeds a first preset number, a number of the to-be-inspected objects failing to pass the quality inspection in the target time period exceeds a second preset number, and the number of the to-be-inspected objects having a defect of the target defect type exceeds a third preset number;
receiving a debugging parameter entered for the quality inspection information, wherein the debugging parameter comprises a working parameter of a process device on the target production line; and
regulating the process device based on the debugging parameter.

17. The quality control method according to claim 1, wherein the defect detection model comprises a first model and a second model, and the performing at least one image acquisition on the to-be-inspected objects produced by the target production line, and inputting at least one acquired image into a defect detection model, so as to perform the quality inspection on the to-be-inspected objects comprises:
inputting the at least one acquired image into the first model, so as to perform a first quality inspection on the to-be-inspected objects; and
when a result of the first quality inspection indicates that the quality inspection fails, re-performing at least one image acquisition on the to-be-inspected objects, and inputting a re-acquired image into the second model, so as to perform a second quality inspection on the to-be-inspected objects;
wherein a quality inspection precision of the first quality inspection is less than a quality inspection precision of the second quality inspection.

18. The quality control method according to claim 1, further comprising:
in a process of performing the quality inspection on the plurality of to-be-inspected objects produced on the target production line, determining a number of the to-be-inspected objects of which the quality inspection is completed within a unit time; and
adjusting a conveying speed of the to-be-inspected objects on the target production line based on the number.

19-22. (canceled)

23. A quality control system, comprising an infrastructure layer and a quality control layer, wherein
the infrastructure layer comprises a plurality of first devices, and different first devices are configured to provide different services required by the quality inspection; and
the quality control layer is in communication with the infrastructure layer and is configured to perform the quality control method according to claim 1.

24-27. (canceled)

28. A manufacturing platform, comprising a computer integrated system, and the quality control system according to claim 23, wherein the quality control system is integrated into the computer integrated system, and the computer integrated system is provided with a production information management system;
wherein the quality control system is in communication with the production information management system;
the quality control system is configured to in response to triggering of a first preset condition, perform quality inspection on a plurality of to-be-inspected objects produced on a target production line; feed back a result of the quality inspection to a control object associated with the target production line, wherein the control object is used for controlling a process flow of the target production line; in response to a second preset condition triggered on the control object, regulate the target production line based on a quality inspection result of at least one to-be-inspected object; and send a debugging instruction to the production information management system when regulating the target production line; and
the production information management system is configured to regulate a process device in the target production line according to the debugging instruction.

29-30. (canceled)
